(19) United States
(12) Patent Application Publication
(10) Pub. No.: US 2015/0093107 A1
(43) Pub. Date: Apr. 2, 2015

(54) RATELESS VISIBLE LIGHT COMMUNICATION

(71) Applicant: QUALCOMM Incorporated, San Diego, CA (US)

(72) Inventors: Aleksandar Jovicic, Jersey City, NJ (US); Mahadevi Pillai Perumal, Piscataway, NJ (US); Thomas Joseph Richardson, South Orange, NJ (US); Junyi Li, Chester, NJ (US)

(73) Assignee: QUALCOMM Incorporated, San Diego, CA (US)

(21) Appl. No.: 14/044,023

(22) Filed: Oct. 2, 2013

(51) Int. Cl. H04L 7/00; H04L 7/033; H04B 10/079; H04B 10/116; H04L 7/027

(52) U.S. Cl. CPC H04L 7/0075; H04B 10/116; H04L 7/027; H04B 10/0795; H04L 7/033
USPC 398/25; 398/130

(57) ABSTRACT

Methods, systems, apparatuses, and devices are described for transmitting and receiving data using rateless visible light communication (VLC). A codeword having a plurality of symbols is identified. The codeword is repetitively transmitted in a VLC signal while, from one transmission of the codeword to a next transmission of the codeword, imparting changes in timings of the symbols of the codeword relative to a timing reference of an image capture frame of an image sensor configured to receive the codeword. A VLC signal including repetitions of a codeword is received. The codeword has a plurality of symbols. A determination is made regarding whether at least one symbol of the codeword is undetected in a repetition of the codeword. Upon determining that the at least one symbol is undetected in the repetition of the codeword, at least one other repetition of the codeword is searched to detect the at least one symbol.

### BACKGROUND

The following relates generally to visible light communication, and more specifically to rateless visible light communication. Visible light communication (VLC) includes performing communications using modulation of the light intensity of a light source (e.g., the modulation of the light intensity of one or more light emitting diodes (LEDs)). General visible light communication is performed by transmitting, at a transmitter, visible light using a light source such as an LED, a Laser Diode (LD), etc., and processing, at a receiver, the visible light using a Photo Detector (PD), or an array of PDs, such as a complementary metal-oxide-semiconductor (CMOS) image sensor (e.g., a camera).

As the light emission efficiency of the LED is improved and the cost thereof decreases, the LED has become common in use in general lighting applications for residential, commercial, outdoor, and industrial market segments. The LED has also become common in special lighting applications as portable devices, display devices, vehicles, sign lamps, signboards, etc. By blinking the LED at a high speed at which the blinking cannot be perceived by a human being, it is possible to transmit data at high speeds. The distance and position of the receiver from the light source, however, may impact the receiver's ability to correctly demodulate and decode the data communicated from the light source using VLC signals. For example, if the receiver is a certain distance away from the light source, the receiver may only be able to demodulate and decode a portion of the VLC signal. Further, erasures of a portion of the transmitted data may be inherent in the receiver as a result of a rolling shutter in the receiver. As a result, the receiver may not receive all of the information and data being transmitted by the light source.

### SUMMARY

The described features generally relate to one or more improved methods, systems, apparatuses, and/or devices for transmitting or receiving data using rateless visible light communication (VLC). Rateless VLC is a communication method in which a VLC source may repetitively transmit the symbols of a codeword (e.g., a codeword corresponding to a piece of information or message) and a VLC-compatible device (or devices) in the vicinity of the VLC source may receive and decode transmissions of the codeword until it detects all of the codeword's symbols and is able to reconstruct the codeword.

A method for transmitting data using rateless VLC is described. In one configuration, a codeword having a plurality of symbols may be identified. The codeword may be repetitively transmitted in a VLC signal while, from one transmission of the codeword to a next transmission of the codeword, imparting changes in timings of the symbols of the codeword relative to a timing reference of an image capture frame of an image sensor configured to receive the codeword.

In some embodiments, imparting changes in timings of the symbols of the codeword relative to the timing reference of the image capture frame of the image sensor may include changing positions of the plurality of symbols within the codeword using a permutation function. In some cases, the permutation function may pseudo-randomly change positions of the plurality of symbols within the codeword. In other cases, the permutation function may cyclically shift positions of the plurality of symbols within the codeword.

In some embodiments, imparting changes in timings of the symbols of the codeword relative to the timing reference of the image capture frame of the image sensor may include identifying a codeword having a transmission time that differs from a frame duration of the image capture frame of the image sensor. In some cases, the transmission time of the codeword may be shorter than the frame duration.

In some embodiments, repetitively transmitting the codeword may include transmitting instances of the codeword back-to-back.

In some embodiments, the timing reference of the image capture frame may be a periodic start time of the image capture frame.

In some embodiments, the codeword may be transmitted as a sequence of pulses in time, with each pulse representing a symbol that conveys at least one bit of information. In some cases, a dimness level of a light source from which the VLC signal is transmitted may be identified, and a duty cycle of the VLC signal may be adjusted based at least in part on the identified dimness level of the light source. In some cases, it may be determined whether the duty cycle of the VLC signal exceeds a threshold. Upon determining that the duty cycle exceeds the threshold, the codeword may be repetitively transmitted by modulating the VLC signal with pulses having a first polarity. Upon determining that the duty cycle fails to exceed the threshold, the codeword may be repetitively transmitted by modulating the VLC signal with pulses having a second polarity. The second polarity may be opposite from the first polarity. In some cases, the pulses having the first polarity may include a high to low transition followed by a low to high transition, and the pulses having the second polarity may include a low to high transition followed by a high to low transition. In some cases, a position of a pulse within a symbol period may convey the at least one bit of information.

In some embodiments, a synchronization signal may be repetitively transmitted. Each transmission of the codeword may be associated with a transmission of the synchronization signal. In some cases, the codeword may be transmitted as a sequence of pulses in time, with each pulse representing a symbol that conveys at least one bit of information. The synchronization signal may include at least two pulses, of which any two consecutive pulses have a spacing in time that differs from 1) a spacing in time between any two consecutive pulses of the codeword, and 2) a spacing in time between a pulse of the synchronization signal and a pulse of the codeword. In some cases, a transmission of the synchronization signal may precede a transmission of the codeword.

In some embodiments, the codeword may include a binary pulse position modulated (PPM) codeword.

In some embodiments, the codeword may encode an identifier uniquely identifying a light source.

An apparatus for transmitting data using rateless VLC is also described. In one configuration, the apparatus may include a means for identifying a codeword having a plurality of symbols, and a means for repetitively transmitting the codeword in a VLC signal while, from one transmission of the codeword to a next transmission of the codeword, imparting changes in timings of the symbols of the codeword relative to a timing reference of an image capture frame of an image sensor configured to receive the codeword.

Another apparatus for transmitting data using rateless VLC is also described. In one configuration, the apparatus may include a processor, memory in electronic communication with the processor, and instructions stored in the memory. The instructions may be executable by the processor to identify a codeword having a plurality of symbols, and to repetitively transmit the codeword in a VLC signal while, from one transmission of the codeword to a next transmission of the codeword, imparting changes in timings of the symbols of the codeword relative to a timing reference of an image capture frame of an image sensor configured to receive the codeword.

A computer program product for transmitting data using rateless VLC is also described. In one configuration, the computer program product may include a non-transitory computer-readable medium storing instructions executable by a processor. The instructions may be executable by the processor to identify a codeword having a plurality of symbols, and to repetitively transmit the codeword in a VLC signal while, from one transmission of the codeword to a next transmission of the codeword, imparting changes in timings of the symbols of the codeword relative to a timing reference of an image capture frame of an image sensor configured to receive the codeword.

A method for receiving data using rateless VLC is described. In one configuration, a VLC signal including repetitions of a codeword may be received. The codeword may have a plurality of symbols. A determination may be made regarding whether at least one symbol of the codeword is undetected in a repetition of the codeword, and upon determining that the at least one symbol is undetected in the repetition of the codeword, at least one other repetition of the codeword may be searched to detect the at least one symbol.

In some embodiments, changes in timings of the symbols of the codeword relative to a timing reference of an image capture frame of an image sensor at which the codeword is received may be identified, from one received repetition of the codeword to a next received repetition of the codeword.

In some embodiments, the received VLC signal may include repetitions of a synchronization signal, and a timing of one or more symbols of the codeword may be determined based at least in part on the synchronization signal. In some cases, changes in timings of the symbols of the codeword relative to a timing reference of an image capture frame of an image sensor at which the codeword is received may be identified, from one received repetition of the codeword to a next received repetition of the codeword, at least in part based on timings of the repetitions of the synchronization signal with respect to the timing reference of the image capture frame.

In some embodiments, the codeword may be reconstructed based at least in part on symbols of the codeword detected in different repetitions of the codeword.

In some embodiments, the VLC signal may be received via a complementary metal-oxide semiconductor (CMOS) image sensor.

An apparatus for receiving data using rateless VLC is also described. In one configuration, the apparatus may include a means for receiving a VLC signal comprising repetitions of a codeword having a plurality of symbols, means for determining whether at least one symbol of the codeword is undetected in a repetition of the codeword, and means for, upon determining that the at least one symbol is undetected in the repetition of the codeword, searching at least one other repetition of the codeword to detect the at least one symbol.

Another apparatus for receiving data using rateless VLC is also described. In one configuration, the apparatus may include a processor, memory in electronic communication with the processor, and instructions stored in the memory. The instructions may be executable by the processor to receive a VLC signal comprising repetitions of a codeword having a plurality of symbols, determine whether at least one symbol of the codeword is undetected in a repetition of the codeword, and upon determining that the at least one symbol is undetected in the repetition of the codeword, search at least one other repetition of the codeword to detect the at least one symbol.

A computer program product for receiving data using rateless VLC is also described. The computer program product may include a non-transitory computer-readable medium storing instructions executable by a processor. The instructions may be executable by the processor to receive a VLC signal comprising repetitions of a codeword having a plurality of symbols, determine whether at least one symbol of the codeword is undetected in a repetition of the codeword, and upon determining that the at least one symbol is undetected in the repetition of the codeword, search at least one other repetition of the codeword to detect the at least one symbol.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a first block diagram of a wireless communications system;

FIG. 2 shows an elevation of a number of VLC-compatible devices, each of which is illuminated by one or more of a number of light sources in accordance with various embodiments;

FIGS. 3A, 3B, and 3C illustrate how respective image sensors of the VLC-compatible devices shown in FIG. 2 might be illuminated by the light source sources shown in FIG. 2, in accordance with various embodiments;

FIGS. 4, 5, 6, 7, and 8 are block diagrams of light sources capable of transmitting VLC signals in accordance with various embodiments;

FIGS. 9, 10, and 11 are block diagrams of VLC-compatible devices capable of receiving VLCs in accordance with various embodiments;

FIGS. 12A, 12B, and 12C show a number of VLC signals having different duty cycles in accordance with various embodiments;

FIG. 13 illustrates a VLC signal in which repetitions of a codeword are transmitted back-to-back across two or more frames of the VLC signal in accordance with various embodiments;

FIG. 14 is a flow chart illustrating a method for transmitting data using rateless VLC, in accordance with various embodiments;

FIG. 15 is a flow chart illustrating another method for transmitting data using rateless VLC, in accordance with various embodiments; and

FIG. 16 is a flow chart illustrating a method for receiving data using VLCs, in accordance with various embodiments.

### DETAILED DESCRIPTION

Transmission and reception of data using rateless VLC is described. As previously mentioned, rateless VLC is a communication method in which a VLC source may repetitively (and in some cases, continually) transmit the symbols of a codeword (e.g., a codeword corresponding to a piece of information or message) and a VLC-compatible device (or devices) in the vicinity of the VLC source may receive and decode transmissions of the codeword until it detects all of the codeword's symbols and is able to reconstruct the codeword. Each repetition of the codeword may convey the same information or message. In practice, the symbols of the codeword may be lost (erased) due to temporary outages in the VLC link (e.g., as a result of physical obstructions, or as a result of an increase in the distance between the VLC source and the receiver of the VLC-compatible device). Because of this property, the communication method may be said to be “rateless”—i.e., the number of codewords that need to be transmitted and received in order to reconstruct the codeword may vary.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

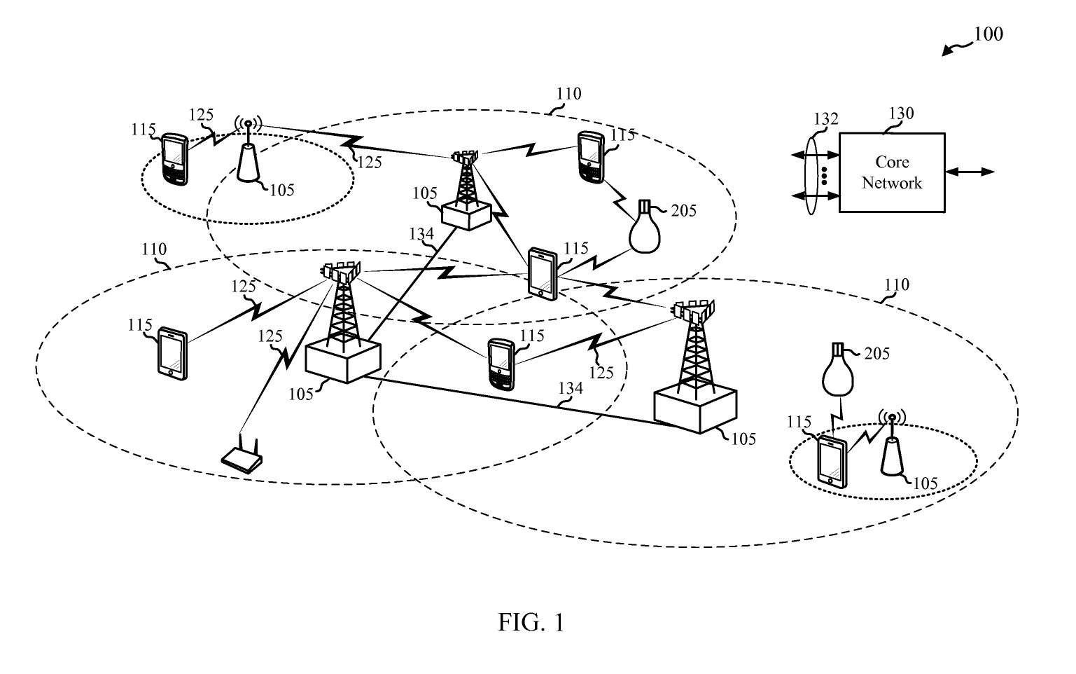

Referring first to FIG. 1, a diagram illustrates an example of a wireless communications system 100. The system 100 may include a plurality of access points (e.g., base stations, eNBs, or WLAN access points) 105, a number of user equipments (UEs) 115, and a core network 130. Some of the access points 105 may communicate with the UEs 115 under the control of a base station controller (not shown), which may be part of the core network 130 or certain access points 105 (e.g., base stations or eNBs) in various embodiments. Some of the access points 105 may communicate control information and/or user data with the core network 130 through backhaul 132. In some embodiments, some of the access points 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to various radio technologies. Each modulated signal may be sent on a different carrier and may carry control information (e.g., reference signals, control channels, etc.), overhead information, data, etc.

The access points 105 may wirelessly communicate with the UEs 115 via one or more access point antennas. Each of the access points 105 may provide communication coverage for a respective coverage area 110. In some embodiments, an access point 105 may be referred to as a base station, a base transceiver station (BTS), a radio base station, a radio transceiver, a basic service set (BSS), an extended service set (ESS), a NodeB, an evolved NodeB (eNB), a Home NodeB, a Home eNodeB, a WLAN access point, or some other suitable terminology. The coverage area 110 for an access point may be divided into sectors making up only a portion of the coverage area (not shown). The system 100 may include access points 105 of different types (e.g., macro, micro, and/or pico base stations). The access points 105 may also utilize different radio technologies. The access points 105 may be associated with the same or different access networks. The coverage areas of different access points 105, including the coverage areas of the same or different types of access points 105, utilizing the same or different radio technologies, and/or belonging to the same or different access networks, may overlap.

In some embodiments, the system 100 may be or include an LTE/LTE-A communications system (or network). In LTE/LTE-A communications systems, the term evolved Node B (eNB) may be generally used to describe the access points 105. The system 100 may also be a Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the eNBs 105 via a backhaul 132 (e.g., S1, etc.). The eNBs 105 may also communicate with one another, e.g., directly or indirectly via backhaul links 134 (e.g., X2, etc.) and/or via backhaul 132 (e.g., through core network 130). The wireless communications system 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The UEs 115 may be dispersed throughout the wireless communications system 100, and each UE 115 may be stationary or mobile. A UE 115 may also be referred to by those skilled in the art as a mobile device, a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like. A UE may also be able to communicate over different access networks, such as cellular or other WWAN access networks, or WLAN access networks.

The communication links 125 shown in system 100 may include uplinks for carrying uplink (UL) transmissions (e.g., from a UE 115 to an eNB 105) and/or downlinks for carrying downlink (DL) transmissions (e.g., from an eNB 105 to a UE 115). The UL transmissions may also be called reverse link transmissions, while the DL transmissions may also be called forward link transmissions.

In some cases, the UEs 115 may be VLC-compatible devices capable of receiving data using rateless VLCs. When illuminated by a light source 205 capable of transmitting data using rateless VLC, a VLC-compatible device 115 may receive and decode a VLC signal transmitted by the light source 205. The VLC signal may include a repeated codeword. From one transmission of the codeword to a next transmission of the codeword, there may be changes in timings of the symbols of the codeword relative to a timing reference of an image capture frame of an image sensor configured to receive the codeword (e.g., an image sensor of one of the VLC-compatible devices 115). In one configuration, the codeword enables the VLC-compatible device 115 to identify the light source 205 that transmitted the VLC signal and determine, for example, positioning information of the light source 205 or the VLC-compatible device 115. In other embodiments, and by way of example only, a VLC-compatible device 115 may utilize the codeword to obtain the information equivalent to that contained in a quick response (QR) code or similar information item, for the purpose of accessing a web page, file, or other information to which the QR code points (or indexes).

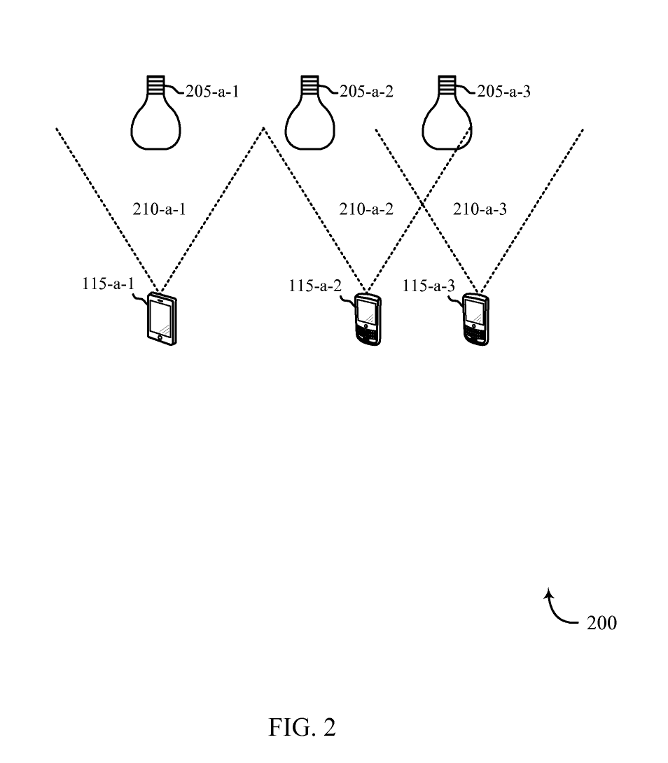

Turning now to FIG. 2, there is shown an elevation of a number of VLC-compatible devices 115-a-1, 115-a-2, 115-a-3, each of which has an image sensor illuminated by one or more of a number of light sources 205-a-1, 205-a-2, 205-a-3 within its image sensor's respective field of view 210-a-1, 210-a-2, 210-a-3. By way of example, the VLC-compatible device 115-a-1 is shown to have an image sensor illuminated by the light source 205-a-1; the VLC-compatible device 115-a-2 is shown to have an image sensor illuminated by the light source 205-a-2 and the light source 205-a-3; and the VLC-compatible device 115-a-3 is shown to have an image sensor illuminated by the light source 205-a-3. The VLC-compatible devices 115-a-1, 115-a-2, 115-a-3 may be examples of one or more aspects of the UEs 115 described with reference to FIG. 1. The light sources 205-a-1, 205-a-2, 205-3 may take various forms, and in some embodiments may each include a light emitting diode (LED) luminary, a compact fluorescent lighting (CFL) luminary, an incandescent luminary, and/or another form of luminary. In some cases, the light sources may be suspended from or mounted on a ceiling, wall, desktop, or other surface. Different light sources may be suspended from or mounted on different surfaces. Each of the light sources 205-a-1, 205-a-2, 205-a-3 may also represent a singular luminarye, a combination of luminaries, or a complex array of luminaries as might be found in a television, computer screen, or electronic sign or billboard.

Each of the light sources 205-a-1, 205-a-2, 205-a-3 may contain (or be associated with) circuitry for generating a VLC signal. The VLC signal may be generated using the primary luminary of the light source 205-a-1, 205-a-3, 205-a-3 or a secondary luminary of the light source 205-a-1, 205-a-2, 205-a-3, such as a luminary provided particularly for the purpose of generating a VLC signal. In the latter case, and by way of example, a light source might use a CFL luminary as its primary light producing mechanism and use an LED luminary for the purpose of generating a VLC signal.

Each of the VLC-compatible devices 115-a-1, 115-a-2, 115-a-3 may include circuitry for receiving and digitizing a received VLC signal. The circuitry may in some cases include an image sensor such as a complementary metal-oxide semiconductor (CMOS) image sensor.

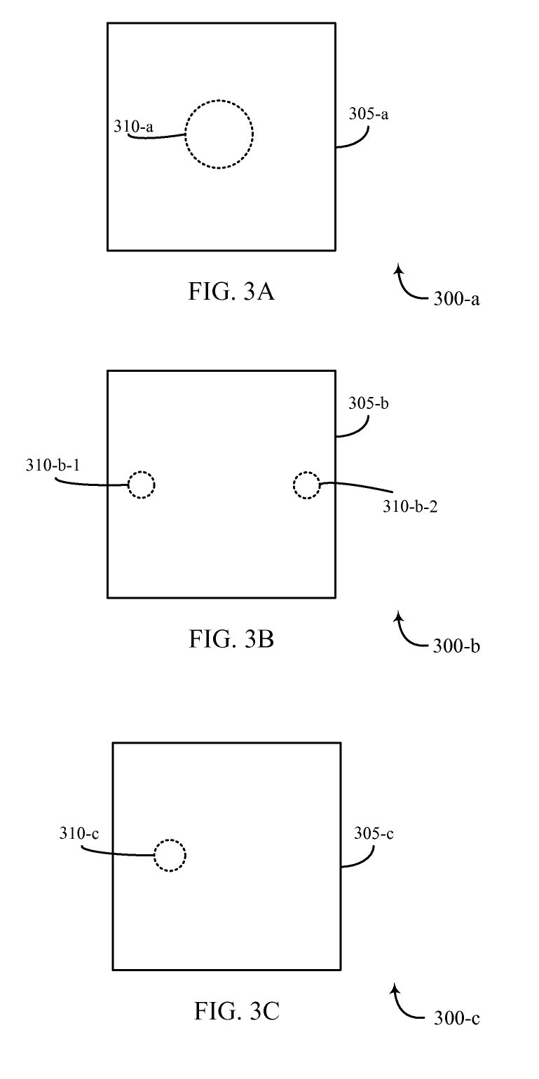

FIGS. 3A, 3B, and 3C illustrate how respective image sensors of the VLC-compatible devices 115-a-1, 115-a-2, 115-a-3 shown in FIG. 2 might be illuminated by the light sources 205-a-1, 205-a-2, 205-a-3 shown in FIG. 2. For example, FIG. 3A illustrates a plan view 300-a of an image sensor 305-a of the VLC-compatible device 115-a-1. As shown, the light source 205-a-1, being directly above the VLC-compatible-device 115-a-1, illuminates a central portion 310-a of the image sensor 305-a. FIG. 3B illustrates a plan view 300-b of an image sensor 305-b of the VLC-compatible device 115-a-2. As shown, the light source 205-a-2 illuminates a small group of pixels 310-b-1 near one edge of the image sensor 305-b, and the light source 205-a-3 illuminates a small group of pixels 310-b-2 near another edge of the image sensor 305-b. FIG. 3C illustrates a plan view 300-c of an image sensor 305-c of the VLC-compatible device 115-a-3. As shown, the light source 205-a-3 illuminates a moderate-sized portion 310-c of the image sensor 305-c.

Typically, a VLC-compatible device positioned closer and/or more centrally within the field of illumination of a light source (e.g., the VLC-compatible device 115-a-1) may receive from the light source a higher intensity VLC signal and/or VLC signal that is less susceptible to fading. In contrast, a VLC-compatible device positioned farther and/or less centrally within the field of illumination of a light source (e.g., the VLC-compatible device 115-a-2 or 115-a-3) may receive from the light source a lower intensity VLC signal and/or VLC signal that is more susceptible to fading. In some cases, an image sensor may have a rolling shutter that captures pulses of a VLC signal as one or more exposed lines of an image capture frame of the image sensor. When the image sensor is in closer proximity to a VLC light source, many pulses (lines) can be detected and the decoding latency, in principle, should be low, since fewer image capture frames (and perhaps only one) would be required to detect all of the pulses or symbols of a codeword transmitted in a VLC signal. However, when the VLC light source is farther away from the image sensor, fewer pulses or symbols of a codeword can be detected per image capture frame. In other words, the number of symbol erasures is higher when distance between the VLC light source is farther from the image sensor (or when physical obstructions prevent the VLC light source from illuminating a greater area of the image sensor.

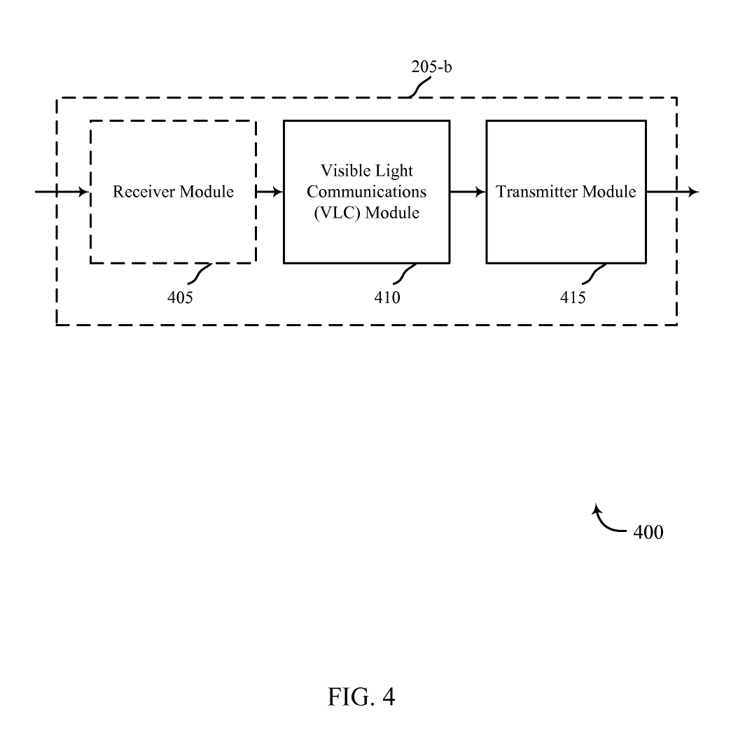

Referring now to FIG. 4, a block diagram 400 illustrates a light source 205-b capable of transmitting data using rateless VLC in accordance with various embodiments. The light source 205-b may be an example of one or more aspects of one of the light sources 205 described with reference to FIG. 2. The light source 205-b may include a receiver module 405, a VLC module 410, and/or a transmitter module 415. Each of these components may, in some cases, be included on a substrate (e.g., a printed circuit board) to which a luminary is attached; be included within a bulb or other package in which a luminary is positioned; be mounted to an exterior surface of a package in which a luminary is positioned; or be otherwise associated with a luminary. Each of these components may be in communication with each other.

The components of the light source 205-b may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 405 may be, or include, a cellular receiver, and in some cases may be or include an LTE/LTE-A receiver or WLAN receiver. The receiver module 405 may be used to receive various types of data and/or control signals (i.e., transmissions) over one or more communication channels of a wireless communications system such as the wireless communications system 100 shown in FIG. 1. The receiver module 405 may also be used to receive data and/or control signals over a wired communications system. In some embodiments, the receiver module 405 may receive communications over a power delivery system that supplies power to the light source 205-b (e.g., communications modulated on a current or voltage signal). The communications received via the receiver module 405 may include, for example, the identity of a codeword to be transmitted in a VLC signal of the light source 205-b. In some embodiments, the light source 205-b may not include the receiver module 405 and the codeword may be statically programmed into the light source 205-b (e.g., a programmable logic device or microcontroller of the light source 205-b) when the light source 205-b is manufactured.

The VLC module 410 may identify a codeword having a plurality of symbols. The codeword may be identified upon receipt via the receiver module 405 or upon retrieval from a memory included in or associated with the light source 205-b. The VLC module 410 may, from one transmission of the codeword to a next transmission of the codeword by the transmitter module 415, impart changes in timings of the symbols of the codeword relative to a timing reference of an image capture frame of an image sensor configured to receive the codeword. The changes in the timings of the symbols may help to account for erasures of codeword symbols, at a receiver of a VLC-compatible device 115, due to temporary outages in a VLC link (e.g., as a result of physical obstructions, or as a result of an increase in the distance between a VLC source and the receiver of the VLC-compatible device 115).

The transmitter module 415 may be or include a VLC transmitter and may repetitively transmit the codeword in a VLC signal. In some cases, the transmitter module 415 may also include one or more other transmitters.

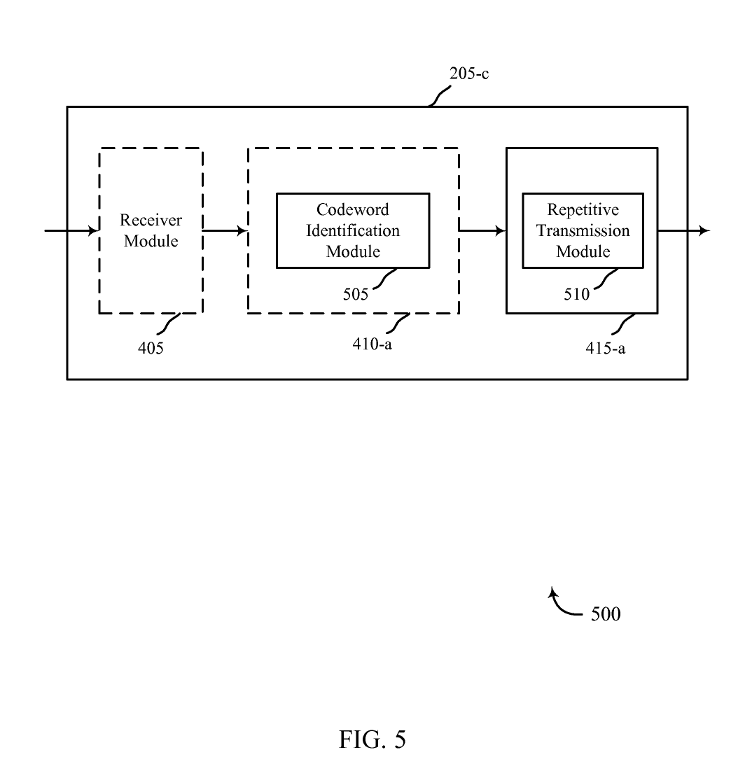

Referring now to FIG. 5, a block diagram 500 illustrates a light source 205-c capable of transmitting data using rateless VLC in accordance with various embodiments. The light source 205-c may be an example of one or more aspects of one of the light sources 205 described with reference to FIG. 2 and/or 4. The light source 205-c may include a receiver module 405, a VLC module 410-a, and/or a transmitter module 415-a. Each of these components may in some cases be included on a substrate (e.g., a printed circuit board) to which a luminary is attached; be included within a bulb or other package in which a luminary is positioned; be mounted to an exterior surface of a package in which a luminary is positioned; or be otherwise associated with a luminary. Each of these components may be in communication with each other.

The components of the light source 205-c may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The receiver module 405 may be configured similarly to what is described with reference to FIG. 4. The VLC module 410-a may be an example of aspects of the VLC module 410 described with reference to FIG. 4 and may include a codeword identification module 505. The transmitter module 415-a may be an example of aspects of the transmitter module 415 described with reference to FIG. 4 and may include a repetitive transmission module 510. Each of these components may be in communication with each other.

The codeword identification module 505 may identify a codeword, in part, based on transmissions received via the receiver module 405 or information retrieved from a memory included in or associated with the light source 205-c. In some cases, the codeword may encode an identifier, such as a Media Access Control (MAC) address, that uniquely identifies the light source 205-c. In other cases, the codeword may be a non-unique identifier that has a high probability of being unique within a particular geographic region. In still other cases, the generated codeword may be one of a smaller set of codewords. Less unique identifiers may be mapped to codewords that are shorter in duration, which codewords may be less complicated to transmit or receive. However, unique identifiers have the advantage of being able to uniquely identify a light source in the absence of accessing other information about the environment of the light source and/or the VLC-compatible device that is receiving the light source's VLC signal. In some embodiments, the codeword may be encoded using a Bose-Chadhuri-Hocquenghem (BCH) block code.

The transmitter module 415 may be or include a VLC transmitter and may further include the repetitive transmission module 510. The repetitive transmission module 510 may repetitively transmit the codeword in a VLC signal as a sequence of pulses in time. Each pulse may represent a symbol that conveys at least one bit of information. A position of a pulse within a symbol period may convey the at least one bit of information.

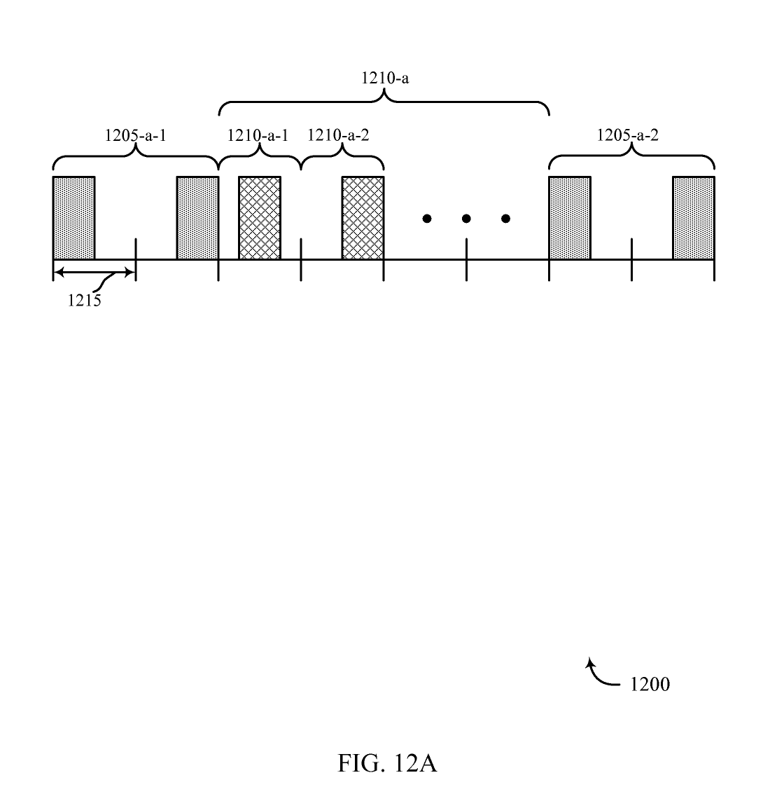

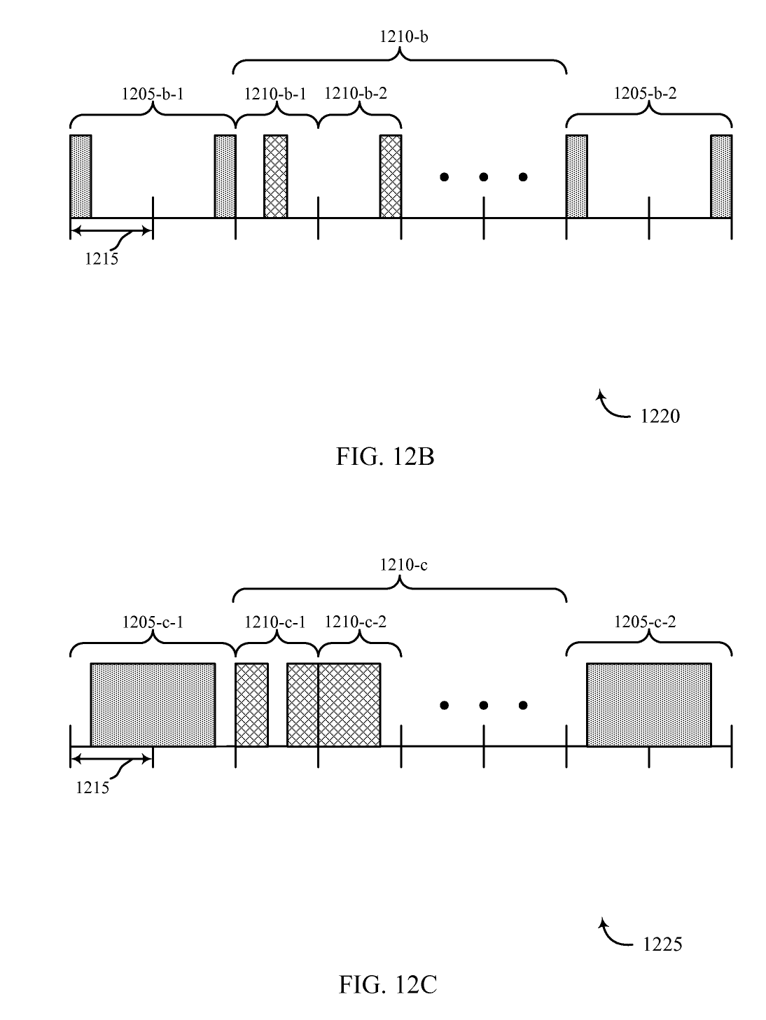

In some embodiments, the repetitive transmission module 510 may modulate the codeword using binary pulse position modulation (PPM). Examples of PPM codewords are described later in this description, with particular reference to FIGS. 12A, 12B, and 12C.

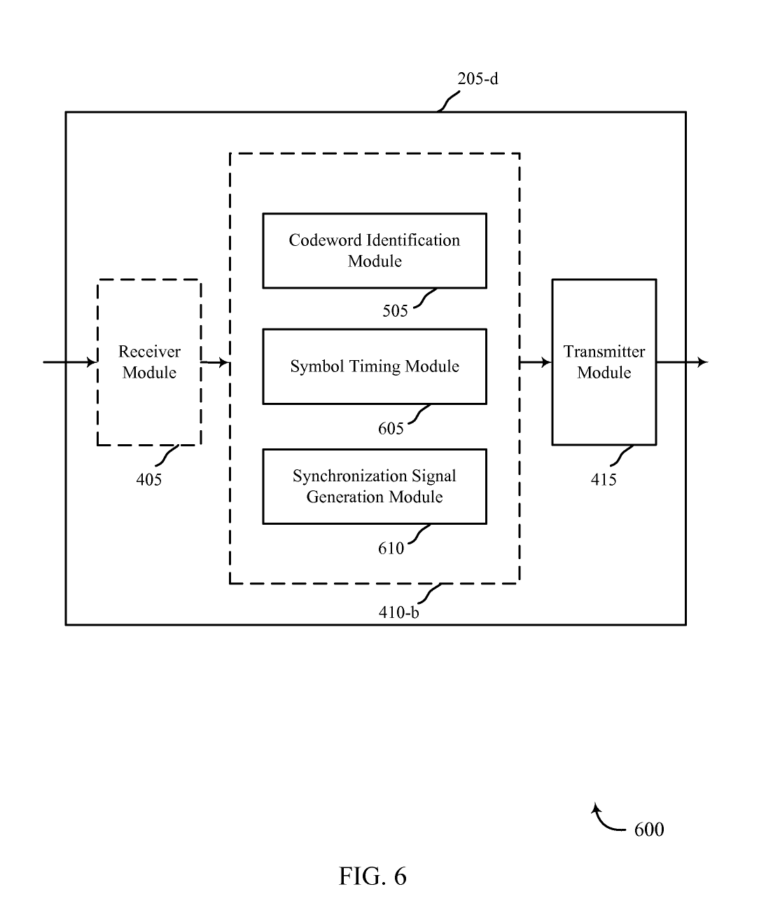

Referring now to FIG. 6, a block diagram 600 illustrates a light source 205-d capable of transmitting data using rateless VLC in accordance with various embodiments. The light source 205-d may be an example of one or more aspects of one of the light sources 205 described with reference to FIG. 2, 4, and/or 5. The light source 205-d may include a receiver module 405, a VLC module 410-b, and/or a transmitter module 415. Each of these components may in some cases be included on a substrate (e.g., a printed circuit board) to which a luminary is attached; be included within a bulb or other package in which a luminary is positioned; be mounted to an exterior surface of a package in which a luminary is positioned; or be otherwise associated with a luminary. Each of these components may be in communication with each other.

The components of the light source 205-d may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The receiver module 405 and transmitter module 415 may be configured similarly to what is described with reference to FIG. 4 and/or 5. The VLC module 410-b may be an example of aspects of the VLC module 410 described with reference to FIG. 4 and/or 5 and may include a codeword identification module 505, a symbol timing module 605, and/or a synchronization signal generation module 610. The codeword identification module 505 may be configured similarly to the codeword identification module 505 described with reference to FIG. 5.

In some embodiments, the symbol timing module 605 may impart changes in timings of the symbols of the identified codeword, relative to a timing reference of an image capture frame of an image sensor configured to receive the codeword, from one transmission of the codeword to a next transmission of the codeword. In some cases, imparting changes in timings of the symbols of the codeword relative to the timing reference of the image sensor may include changing positions of the plurality of symbols within the codeword using a permutation function.

The permutation function may, for example, pseudo-randomly change positions of the plurality of symbols within the codeword or cyclically shift positions of the plurality of symbols within the codeword. By way of further example, let a set of K symbols corresponding to the codeword be denoted by {s(1), s(2), . . . , s(K)}. Then, the order of symbols in a transmission of the codeword i may be {s(p_{—}1(i)), s(p_{—}2(i)), . . . , s(p_KW)} where, for each integer i in a set, p_j(i) represents a permutation function. The permutation function may in some cases be a one-to-one mapping of integers j between 1 and K. For example, in a cyclic shift permutation function, the first codeword of a subsequence of codewords may be {s(1), s(2), . . . , s(K)}, the second codeword may be {s(2), s(3), . . . , s(K), s(1)}, the third codeword may be {s(3, s(4), . . . , s(K−1), s(K), s(1), s(2)}, and so on. The number of codewords in such a subsequence of codewords, in this case, would be equal to K.

In other cases, imparting changes in timings of the symbols of the codeword relative to the timing reference of the image capture frame of the image sensor may include identifying a codeword having a transmission time that differs from (e.g., is shorter or longer than) a frame duration of the image capture frame of the image sensor. In this manner, the transmission of instances of the codeword back-to-back may cause the timings of the symbols within the codeword to change with respect to the timing reference of the image capture frame of the image sensor. In some cases, the timing reference may be a periodic start time of the image capture frame.

The frame duration of an image capture frame of an image sensor may not be exactly known by a light source 205 capable of transmitting data using rateless VLC. The transmitting light source 205 may therefore need to make an assumption about the frame duration. In some cases, the transmitting light source 205 may assume that the frame duration is 1/(k*30) seconds, where k is an integer greater than or equal to 1. Such an assumption includes default frame duration values for the vast majority of image sensors previously or currently on the market, and is expected to include frame durations values for image sensors to be released in the future. In some embodiments, the codeword duration may be less than the frame duration and the difference between the codeword duration and the frame duration may be at least 10% of the frame duration. This causes the codeword symbols to shift by roughly 11% from one image capture frame to the next. The codeword duration should typically not be too small relative to the frame duration, because this may reduce the maximum number of bits that may be transmitted. In other embodiments, the codeword duration may be longer than the frame duration. In this case, the codeword duration should typically not be a multiple of the frame duration and should be at least 110% of the frame duration. However, the codeword duration should typically not be too long, because long codeword durations may increase the latency of decoding.

The changes in the timings of the symbols made by the symbol timing module 605 may help to account for erasures of codeword symbols, at a receiver of a VLC-compatible device 115, due to temporary outages in a VLC link (e.g., as a result of physical obstructions, or as a result of an increase in the distance between a VLC source and the receiver of the VLC-compatible device 115).

The synchronization signal generation module 615 may generate a repetitive synchronization signal for transmission with the repetitively transmitted codeword. The synchronization signal may in some cases precede the symbols of an instance of the codeword, thereby enabling a VLC-compatible device 115 to synchronize with a transmission of the codeword before decoding the symbols of the codeword. In some embodiments, the synchronization signal may include at least two pulses. In some cases, each of the pulses may be defined by a low to high transition followed by a high to low transition, or by a high to low transition followed by a low to high transition. Any two consecutive pulses of the synchronization signal may have a spacing in time that differs from both 1) a spacing in time between any two consecutive pulses of the codeword, and 2) a spacing in time between a pulse of the synchronization signal and a pulse of the codeword. This may enable a VLC-compatible device to detect the synchronization signal from amongst the symbols of consecutive codewords.

The synchronization signal generation module 615 may alternately generate a synchronization signal having more or fewer pulses, or a pulse or pulses of a different type (e.g., a non-binary pulse or pulses).

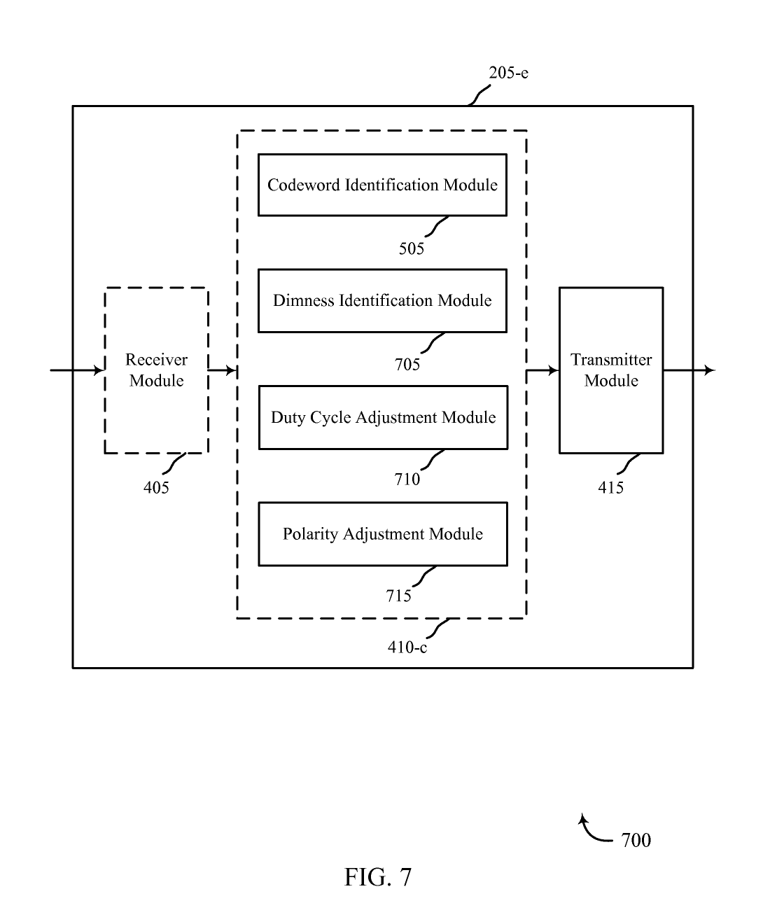

Referring now to FIG. 7, a block diagram 700 illustrates a light source 205-e capable of transmitting data using rateless VLC in accordance with various embodiments. The light source 205-e may be an example of one or more aspects of one of the light sources 205 described with reference to FIG. 2, 4, 5, and/or 6. The light source 205-e may include a receiver module 405, a VLC module 410-c, and/or a transmitter module 415. Each of these components may in some cases be included on a substrate (e.g., a printed circuit board) to which a luminary is attached; be included within a bulb or other package in which a luminary is positioned; be mounted to an exterior surface of a package in which a luminary is positioned; or be otherwise associated with a luminary. Each of these components may be in communication with each other.

The components of the light source 205-e may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The receiver module 405 and transmitter module 415 may be configured similarly to what is described with reference to FIG. 4. The VLC module 410-c may be an example of aspects of the VLC module 410 described with reference to FIG. 4 and/or 5, and may include a codeword identification module 505, a dimness identification module 705, a duty cycle adjustment module 710, and/or a polarity adjustment module 715. The codeword identification module 505 may be configured similarly to what is described in FIG. 5 and/or 6. Each of these components may be in communication with each other.

The dimness identification module 705 may identify a dimness level of the light source from which a VLC signal is transmitted. The light source from which the VLC signal is transmitted may be the primary luminary of the light source 205-e or a secondary luminary of the light source 205-e (e.g., a luminary provided particularly for the purpose of generating the VLC signal). The dimness identification module 705 may identify the dimness (or brightness, or intensity) of the VLC signal. In some cases, the dimness identification module 705 may identify the dimness of the VLC signal using a dimness sensor (e.g., an ambient light sensor or motion sensor) included in or on or otherwise associated with the light source 205-e (e.g., via a wired or wireless interface). In other cases, the dimness identification module 705 may identify the dimness of the VLC signal by receiving a dimness setting via the receiver module 405.

The duty cycle adjustment module 710 may adjust a duty cycle of the VLC signal based at least in part on the identified dimness level of the light source. In some embodiments, the duty cycle may be linearly or logarithmically related to the dimness level. The duty cycle may in some cases decrease as dimness increases (e.g., a dimmer VLC signal may be associated with a lower duty cycle). In an alternate embodiment, the duty cycle may increase as dimness increases (e.g., a dimmer VLC signal may be associated with a higher duty cycle).

The polarity adjustment module 715 may determine whether the duty cycle of the VLC signal satisfies a threshold. Upon determining that the duty cycle satisfies the threshold, the polarity adjustment module 715 may determine that the transmitter module 415 should repetitively transmit the codeword by modulating the VLC signal with pulses having a first polarity. Upon determining that the duty cycle fails to satisfy the threshold, the polarity adjustment module 715 may determine that the transmitter module 415 should repetitively transmit the codeword by modulating the VLC signal with pulses having a second polarity.

The second polarity may be opposite from the first polarity. As an example, the threshold may be a 50% duty cycle. In such an example, and upon determining that the duty cycle of the VLC signal is greater than 50%, the polarity adjustment module 715 may determine that the VLC signal should be modulated with pulses having the first polarity, such as a polarity that results in pulses having a high to low transition followed by a low to high transition (i.e., a negative pulse polarity). Upon determining that the duty cycle of the VLC signal is less than or equal to 50%, the polarity adjustment module 715 may determine that the VLC signal should be modulated with pulses having the second polarity, such as a polarity that results in pulses having a low to high transition followed by a high to low transition (i.e., a positive pulse polarity).

The transmitter module 415 may repetitively transmit the codeword in a VLC signal, according to the adjusted duty cycle and determined polarity.

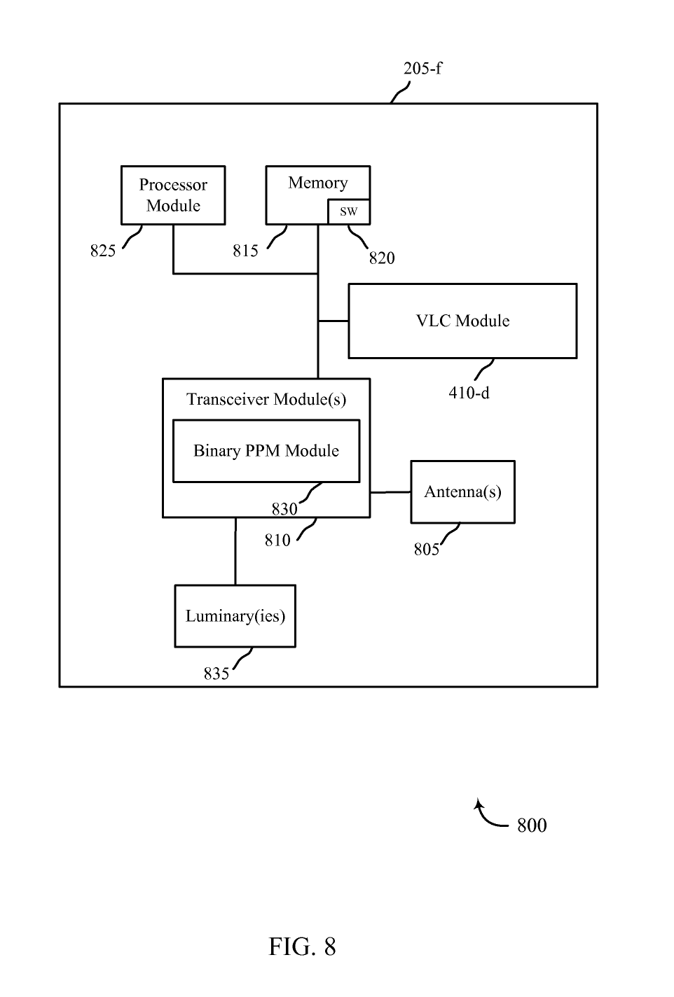

FIG. 8 is a block diagram 800 of a light source 205-f capable of transmitting data using rateless VLC in accordance with various embodiments. The light source 205-f may be an example of one or more aspects of one of the light sources 205 described with reference to FIG. 2, 4, 5, 6, and/or 7. The light source 205-f may have a base or connector (not shown) for connecting the light source 205-f to a power source. Alternately, the light source 205-f may have an internal or integrated power supply or power generator (not shown), such as a small battery, a solar panel, or other source or generator of power.

The light source 205-f may include one or more luminaries 835, antenna(s) 805, transceiver module(s) 810, memory 815, a processor module 825, and/or a VLC module 410-d, each of which may be in communication, directly or indirectly, with each other (e.g., via one or more buses). The transceiver module(s) 810 may be configured to transmit a VLC signal via one or more of the luminaries 835, and in some cases may be configured to sense the dimness level of the VLC signal via a dimness sensor. The transceiver module(s) 810 may include a binary pulse-position modulation (PPM) module 830 configured to modulate the VLC signal for transmission via one or more of the luminaries 835. The transceiver module(s) 810 may also be configured to communicate via the antenna(s) 805 and/or one or more wired or wireless links, with one or more networks, to receive information from (or transmit information such as settings, statuses, etc. to) one or more networks. In some cases, a transceiver module of the transceiver module(s) 810 may be configured to communicate with a communications system such as the wireless communications system 100 described with reference to FIG. 1. For example, the transceiver module(s) 810 may be configured to communicate bi-directionally with an access point 105 shown in FIG.1.

The memory 815 may include random access memory (RAM) and/or read-only memory (ROM). The memory 815 may store computer-readable, computer-executable software code 820 containing instructions that are configured to, when executed, cause the processor module 825 to perform various functions described herein. Alternatively, the software code 820 may not be directly executable by the processor module 825 but be configured to cause the light source 205-f (e.g., when compiled and executed) to perform various functions described herein (e.g., transmission of a VLC signal). In some cases, the memory 815 and/or processor module 825 may be implemented using a programmable logic device (PLD) or microcontroller.

According to the architecture of FIG. 8, the light source 205-f may further include a VLC module 410-d. The VLC module 410-d may be an example of one or more aspects of the VLC module 410 described with reference to FIG. 4, 5, 6, and/or 7.

The components of the light source 205-f may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the light source 205-f.

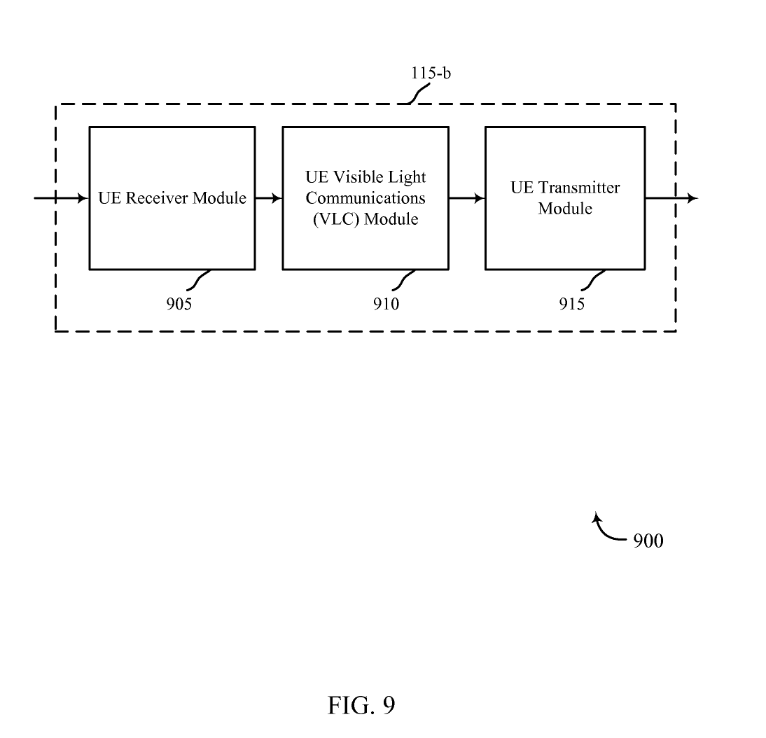

Referring now to FIG. 9, a block diagram 900 illustrates a VLC-compatible device 115-b capable of receiving data using rateless VLCs, in accordance with various embodiments. The VLC-compatible device 115-b may be an example of one or more aspects of one of the UEs or VLC-compatible devices 115 described with reference to FIG. 1, 2 and/or 3. The VLC-compatible device 115-b may also be a processor. The VLC-compatible device 115-b may include a UE receiver module 905, a UE VLC module 910, and/or a UE transmitter module 915. Each of these components may be in communication with each other.

The components of the VLC-compatible device 115-b may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The UE receiver module 905 may include a VLC receiver for receiving VLC signals from one or more light sources 205. In some cases, the VLC receiver may include a CMOS image sensor. The UE receiver module 905 may also include a cellular receiver, and in some cases may be or include an LTE/LTE-A receiver. The cellular receiver may be used to receive various types of data and/or control signals (i.e., transmissions) over one or more communication channels of a wireless communications system, such as the wireless communications system 100 shown in FIG. 1.

The UE transmitter module 915 may be or include a cellular transmitter, and in some cases may be or include an LTE/LTE-A transmitter. The UE transmitter module 915 may be used to transmit various types of data and/or control signals over one or more communication channels of a wireless communications system, such as the wireless communications system 100.

The UE VLC module 910 may receive, via the UE receiver module 905, a VLC signal including repetitions of a codeword having a plurality of symbols. The UE VLC module 910 may then determine whether at least one symbol of the codeword is undetected in a repetition of the codeword, and upon determining that the at least one symbol is undetected in the repetition of the codeword, search at least one other repetition of the codeword to detect the at least one symbol. In this manner, the UE VLC module 910 may be able to reconstruct the codeword in the presence of a fading process.

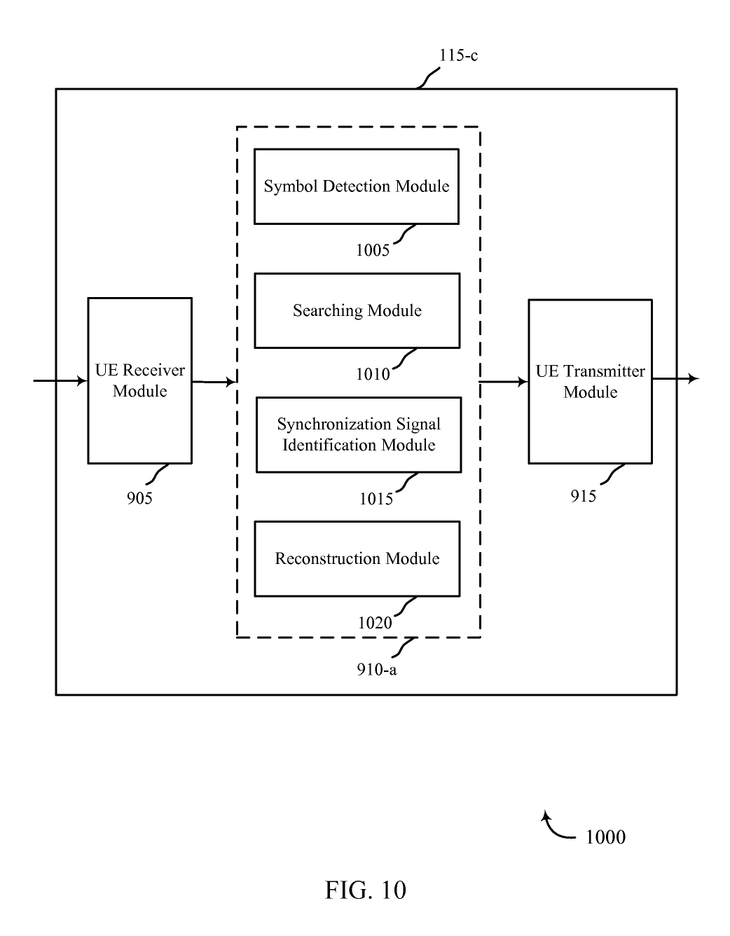

Referring now to FIG. 10, a block diagram 1000 illustrates a VLC-compatible device 115-c capable of receiving data using rateless VLCs, in accordance with various embodiments. The VLC-compatible device 115-c may be an example of one or more aspects of one of the UEs or VLC-compatible devices 115 described with reference to FIG. 1, 2, 3, and/or 4. The VLC-compatible device 115-c may also be a processor. The VLC-compatible device 115-c may include a UE receiver module 905, a UE VLC module 910-a, and/or a UE transmitter module 915. Each of these components may be in communication with each other.

The components of the VLC-compatible device 115-c may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The UE receiver module 905 and UE transmitter module 915 may be configured similarly to what is described with respect to FIG. 9. The UE VLC module 910-a may be an example of aspects of the UE VLC module 910 described with reference to FIG. 9 and may include a symbol detection module 1005, a searching module 1010, a synchronization signal identification module 1015, and/or a codeword reconstruction module 1020.

The symbol detection module 1005 may detect the symbols included in a codeword. Because the duty cycle of a received VLC signal may not be known, the symbol detection module 1005 may estimate the duty cycle of the VLC signal by, for example, averaging the received VLC signal or passing it through a filter bank of pulses to detect the shape of its pulses. In cases where a codeword includes a synchronization signal, this may be done before the synchronization signal is detected.

When detecting the symbols of the codeword, the symbol detection module 1005 may identify changes in timings of the symbols of the codeword relative to a timing reference of an image capture frame of an image sensor at which the codeword is received by the VLC-compatible device 115-c. The changes in timings may be identified at least in part based on timings of the synchronization signal with respect to the timing reference of the image capture frame. The changes in timings may occur from one received instance of the codeword to a next received instance of the codeword.

Under optimum signal reception conditions (e.g., when the VLC-compatible device 115-c is close to the light source transmitting a VLC signal, or is centrally positioned within the field of illumination of the light source), the symbol detection module 1005 may detect all of the symbols of a codeword after receiving and decoding only a single instance of the codeword. However, under less than optimum signal reception conditions, the symbol detection module 1005 may determine that one or more symbols of the codeword were not detected (e.g., due to the presence of a fading process caused by physical obstructions between the VLC-compatible device 115-c and the light source which transmitted the VLC signal and/or by the VLC-compatible device 115-c being too distant from the light source). In these instances, the searching module 1010 may manage a search for at least one other instance of the codeword, so that the symbol detection module 1005 may detect the at least one undetected symbol in another instance of the codeword. In some cases, the at least one other instance of the codeword may follow the instance of the codeword in which the one or more symbols were not detected. In other cases, the VLC-compatible device 115-c may include a buffer in which one or more earlier-received instances of the codeword may be stored, and the at least one other instance of the codeword may precede the instance of the codeword in which the one or more symbols were not detected. The different instances of the codeword may appear in different image capture frames of an image sensor.

In some cases, a received codeword may be associated with a synchronization signal. In these cases, the synchronization signal identification module 1015 may receive the synchronization signal and determine a timing of one or more symbols of the codeword based at least in part on the synchronization signal.

The codeword reconstruction module 1020 may reconstruct a codeword based at least in part on the symbols of the codeword detected in any one or more instances of the codeword.

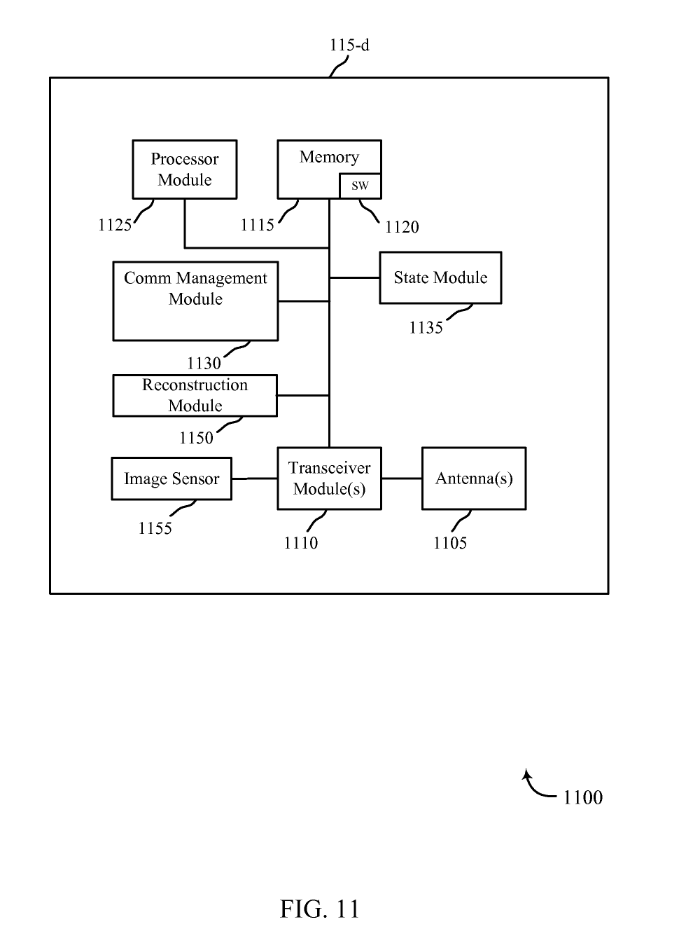

FIG. 11 is a block diagram 1100 illustrating an example of a UE or VLC-compatible device 115-d. The UE or VLC-compatible device 115-d may an example of one or more aspects of the UEs 115 described with reference to FIG. 1, 2, 9, and/or 10. The VLC-compatible device 115-d may assume any of various configurations, such as that of a personal computer (e.g., laptop computer, netbook computer, tablet computer, etc.), a cellular telephone, a PDA, a digital video recorder (DVR), an internet appliance, a gaming console, an e-reader, etc. The device 115-d may have an internal power supply (not shown), such as a small battery, to facilitate mobile operation.

The VLC-compatible device 115-d may include an image sensor 1155, antenna(s) 1105, transceiver module(s) 1110, memory 1115, and/or a processor module 1125, each of which may be in communication, directly or indirectly, with each other (e.g., via one or more buses). The transceiver module(s) 1110 may be configured to receive VLC signals from one or more light sources, such as one or more of the light sources 205 described with reference to FIG. 1, 2, 4, 5, 6, 7 and/or 8. The transceiver module(s) 1110 may be configured to receive the VLC signals via the image sensor 1155, which in some cases may be a CMOS image sensor. The transceiver module(s) 1110 may also allow be configured to communicate bi-directionally, via the antenna(s) 1105 and/or one or more wired or wireless links, to transmit or receive data to/from one or more remote devices over one or more networks. In some cases, and by way of example, the transceiver module(s) 1110 may enable the VLC-compatible device 115-d to receive data and/or control signals from an access point, such as one of the access points 105 described with reference to FIG. 1.

In one embodiment, the device 115-d may include a reconstruction module 1150. The reconstruction module 1150 may reconstruct a codeword transmitted from one or more light sources 205. A codeword may in some cases be reconstructed using symbols detected in different received instances of a codeword. In one example, the VLC-compatible device 115-d may perform the processing to reconstruct the codeword. In another embodiment, the device 115-d may transmit the detected codeword to a remote server via a network connection. The remote server may perform the processing to reconstruct the codeword. In another embodiment, the codeword may be transmitted to an access point 105 or base station to perform the reconstruction. The server, access points, and/or base station may transmit the reconstructed codeword back to the VLC-compatible device 115-d.

In one configuration, the transceiver module 1110 may include a modem configured to modulate packets and provide modulated packets to the antennas 1105 for transmission, and to demodulate packets received from the antennas 1105. While the device 115-d may include a single antenna, the device 115-d may typically include multiple antennas 1105 for multiple links.

The memory 1115 may include random access memory (RAM) and/or read-only memory (ROM). The memory 1115 may store computer-readable, computer-executable software code 1120 containing instructions that are configured to, when executed, cause the processor module 1125 to perform various functions described herein (e.g., call processing, database management, message routing, etc.). Alternatively, the software 1120 may not be directly executable by the processor module 1125 but be configured to cause the device 115-d (e.g., when compiled and executed) to perform various functions described herein.

The processor module 1125 may include an intelligent hardware device, e.g., a central processing unit (CPU), a microcontroller, an ASIC, etc. The processor module 1125 may include a speech encoder (not shown) configured to receive audio via a microphone, convert the audio into packets (e.g., 30 ms in length) representative of the received audio, provide the audio packets to the transceiver module(s) 1110, and provide indications of whether a user is speaking Alternatively, an encoder may only provide packets to the transceiver module(s) 1110, with the provision or withholding/suppression of the packet itself providing the indication of whether a user is speaking

According to the architecture of FIG. 11, the device 115-d may further include a communications management module 1130 and/or a state module 1135. The communications management module 1130 may manage communications with other devices 115. By way of example, the communications management module 1130 may be a component of the device 115-d in communication with some or all of the other components of the device 115-d via a bus. Alternatively, functionality of the communications management module 1130 may be implemented as a component of the transceiver module 1110, as a computer program product, and/or as one or more controller elements of the processor module 1125. The state module 1135 may reflect and control the current device state (e.g., context, authentication, base station association, and/or other connectivity issues).

The components of the device 115-d may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the device 115-d.

FIGS. 12A, 12B, and 12C show a number of VLC signals having different duty cycles. By way of example, the VLC signal 1200 shown in FIG. 12A has a duty cycle of 50%; the VLC signal 1220 shown in FIG. 12B has a duty cycle of 25%; and the VLC signal 1225 shown in FIG. 12C has a duty cycle of 75%.

Turning to FIG. 12A, the VLC signal 1200 may have a duty cycle of 50% and include positive polarity pulses. Each pulse may be confined to one of timeslots 1215. A number of pulses of the VLC signal 1200 may define an instance 1210-a of a codeword. By way of example, the instance 1210-a of the codeword may be preceded by two consecutive pulses defining a synchronization signal 1205-a-1. The first pulse of the synchronization signal 1205-a-1 may be aligned with the beginning of its timeslot, and the second pulse of the synchronization signal 1205-a-1 may be aligned with the end of its timeslot.

Following the pulses of the synchronization signal are a number of symbols. In the example shown, the symbols may be pulse position modulated. For example, some of the symbols (e.g., symbol 1210-a-2) may define logic “0” symbols and may be aligned with the ends of their timeslots. Other symbols (e.g., symbol 1210-a-1) may define logic “1” symbols and may be centered within their timeslots. As shown, a spacing in time between the two consecutive pulses of the synchronization signal 1205-a-1 may differ from both 1) a spacing in time between any two consecutive pulses of the codeword 1210-a, and 2) a spacing in time between a pulse of the synchronization signal 1205-a-1 and a pulse of the codeword 1210-a. This may enable a VLC-compatible device to detect the synchronization signal 1205-a-1 from amongst the symbols of consecutive codewords.

Following the symbols of the instance 1210-a of the codeword, another instance of the codeword may be transmitted, such that instances of the codeword may be transmitted back-to-back, regardless of VLC frame boundaries. However, the next instance of the codeword may in some cases be preceded with a next instance of the synchronization signal 1205-a-2.

Turning to FIG. 12B, the VLC signal 1220 may have a duty cycle of 25% and include positive polarity pulses. Each pulse may be confined to one of timeslots 1215. A number of pulses of the VLC signal 1220 may define an instance 1210-b of a codeword. By way of example, the instance 1210-b of the codeword may be preceded by two consecutive pulses defining a synchronization signal 1205-b-1. Similarly to the VLC signal 1200 having a duty cycle of 50%, the first pulse of the synchronization signal 1205-b-1 may be aligned with the beginning of its timeslot, and the second pulse of the synchronization signal 1205-b-1 may be aligned with the end of its timeslot.

Following the pulses of the synchronization signal are a number of symbols. In the example shown, the symbols may be pulse position modulated. For example, some of the symbols (e.g., symbol 1210-b-2) may define logic “0” symbols and may be aligned with the ends of their timeslots. Other symbols (e.g., symbol 1210-b-1) may define logic “1” symbols and may be centered within their timeslots. As shown, a spacing in time between the two consecutive pulses of the synchronization signal 1205-b-1 may differ from both 1) a spacing in time between any two consecutive pulses of the codeword 1210-b, and 2) a spacing in time between a pulse of the synchronization signal 1205-b-1 and a pulse of the codeword 1210-b. This may enable a VLC-compatible device to detect the synchronization signal 1205-b-1 from amongst the symbols of consecutive codewords.

Following the symbols of the instance 1210-b of the codeword, another instance of the codeword may be transmitted, such that instances of the codeword may be transmitted back-to-back, regardless of VLC frame boundaries. However, the next instance of the codeword may in some cases be preceded with a next instance of the synchronization signal 1205-b-2.

Turning to FIG. 12C, the VLC signal 1225 may have a duty cycle of 75% and include negative polarity pulses. Each pulse may be confined to one of timeslots 1215. A number of pulses of the VLC signal 1225 may define an instance 1210-c of a codeword. By way of example, the instance 1210-c of the codeword may be preceded by two consecutive pulses defining a synchronization signal 1205-c-1. Similarly to the VLC signals 1200, 1220 having duty cycles of 50% and 25%, the first pulse of the synchronization signal 1205-c-1 may be aligned with the beginning of its timeslot, and the second pulse of the synchronization signal 1205-c-1 may be aligned with the end of its timeslot. However, instead of the pulses being positive polarity pulses, the pulses of the VLC signal 1225 may be negative polarity pulses. One reason for the switch in polarity is to prevent the spacing between the pulses from becoming less than (or indistinguishable from) the spacing between the pulses of any two consecutive symbols of the codeword 1210-c.

Following the pulses of the synchronization signal are a number of symbols. In the example shown, the symbols may be pulse position modulated. For example, some of the symbols (e.g., symbol 1210-c-2) define logic “0” symbols and may be aligned with the ends of their timeslots. Other symbols (e.g., symbol 1210-c-1) define logic “1” symbols and may be centered within their timeslots. As shown, a spacing in time between the two consecutive pulses of the synchronization signal 1205-c-1 may differ from both 1) a spacing in time between any two consecutive pulses of the codeword 1210-c, and 2) a spacing in time between a pulse of the synchronization signal 1205-c-1 and a pulse of the codeword 1210-c. This may enable a VLC-compatible device to detect the synchronization signal 1205-c-1 from amongst the symbols of consecutive codewords.

Following the symbols of the instance 1210-c of the codeword, another instance of the codeword may be transmitted, such that instances of the codeword may be transmitted back-to-back, regardless of VLC frame boundaries. However, the next instance of the codeword may in some cases begin with a next instance of the synchronization signal 1205-c-2.

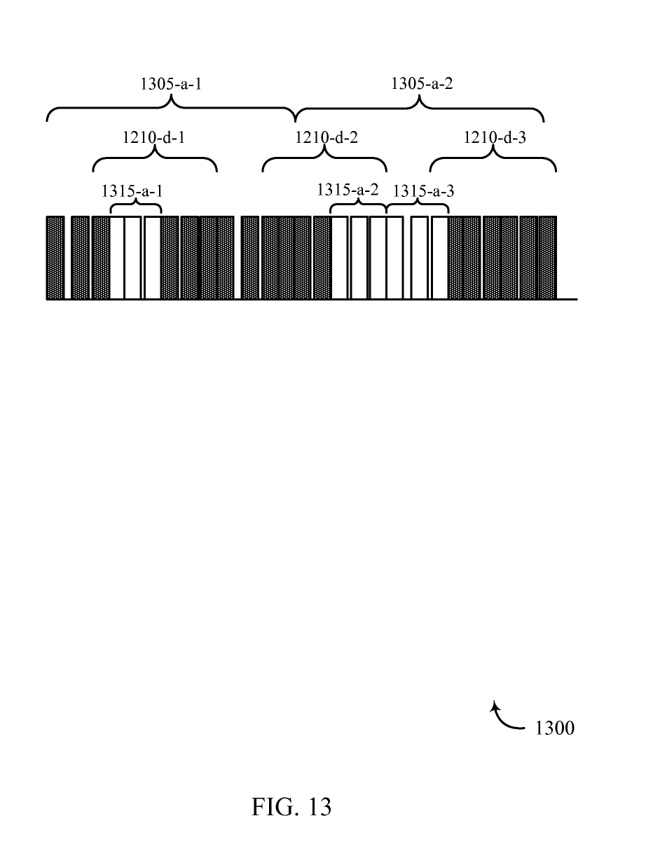

FIG. 13 illustrates a VLC signal 1300 in which instances 1210-d-1, 1201-d-2, 1210-d-3 of a codeword, preceded by synchronization signals, may be transmitted back-to-back across two or more image capture frames 1305-a-1, 1305-a-2 of a VLC-compatible device 115. As disclosed in FIGS. 3B and 3C, temporary outages in a VLC link due to physical obstructions and longer distances between a VLC-compatible device 115 and a light source 205, as well as other effects, may result in a fading process. The fading process may result in some of the symbols of a codeword (or even the synchronization signal associated with a codeword) not being detected by the VLC-compatible device 115. This is illustrated in FIG. 13 by shading of the symbols of a codeword that are not detected by a particular VLC-compatible device 115.

The fading process may sometimes be geometry-dependent (e.g., a result of the angle at which a light source 205 subtends at a receiver or image sensor (e.g., one of the image sensors 305-a, 305-, 305-c shown in FIG. 3A, 3B, or 3C). That is, the orientation of the image sensor may tend to determine which symbols are erased. This may result in a VLC-compatible device 115 being able to detect only the symbols transmitted at particular times with respect to a frame duration of an image capture frame of an image sensor receiving the VLC signal. To account for symbol erasure, changes in timings of the symbols of a codeword relative to a timing reference of an image capture frame of an image sensor may be imparted from one transmission of the codeword to a next transmission of the codeword.

In some cases, imparting changes in timings of the symbols of the codeword relative to the timing reference of the image sensor may include changing positions of the plurality of symbols within the codeword using a permutation function. The permutation function may, for example, pseudo-randomly change positions of the plurality of symbols within the codeword or cyclically shift positions of the plurality of symbols within the codeword. In other cases, imparting changes in timings of the symbols of the codeword relative to the timing reference of the image capture frame of the image sensor may include identifying a codeword having a transmission time that differs from (e.g., is shorter or longer than) a frame duration of the image capture frame of the image sensor. In this manner, the transmission of instances of the codeword back-to-back may cause the timings of the symbols within the codeword to change with respect to the timing reference of the image capture frame of the image sensor. In some cases, the timing reference may be a periodic start time of the image capture frame.

By way of example, FIG. 13 illustrates different sets of symbols 1315-a-1, 1315-a-2 being detected by an image sensor from one image capture frame 1305-a-1 to another image capture frame 1305-a-2. A VLC-compatible device 115 may also be moved closer to a light source 205 to improve its VLC signal reception, thereby increasing the size of the detectable window so that it includes additional symbols (e.g., the sets of symbols 1315-a-2 and 1315-a-3).

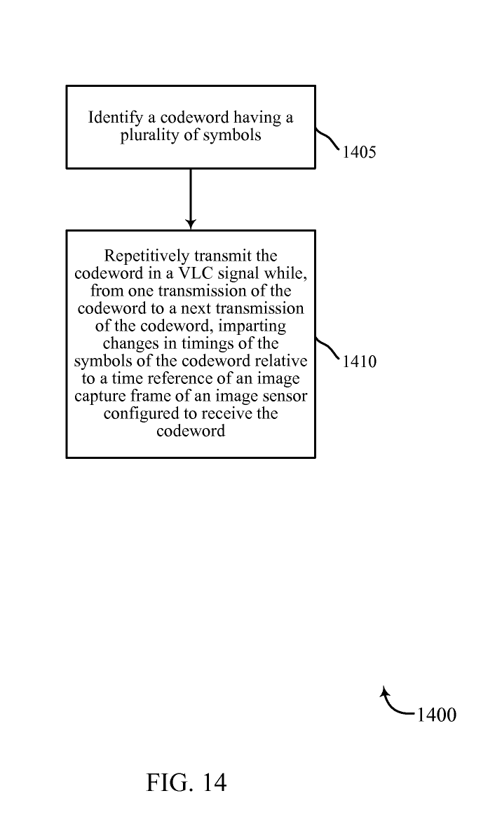

FIG. 14 is a flow chart illustrating an embodiment of a method 1400 for transmitting data using rateless VLC. For clarity, the method 1400 is described below with reference to one of the light sources 205 described with reference to FIG. 1, 2, 3, 4, 5, 6, 7, and/or 8. In one implementation, the VLC module 410 described with reference to FIG. 4, 5, 6, 7 and/or 8 may execute one or more sets of codes to control the functional elements of a light source 205 to perform the functions described below.

At block 1405, a codeword having a plurality of symbols may be identified. In some cases, the codeword may encode an identifier, such as a MAC address, that uniquely identifies a particular light source. In other cases, the codeword may encode a non-unique identifier that has a high probability of being unique within a particular geographic region. In still other cases, the codeword may encode one of a smaller set of codewords. Less unique identifiers may be mapped to codewords that are shorter in duration, which codewords may be less complicated to transmit or receive. However, unique identifiers have the advantage of being able to uniquely identify a light source in the absence of accessing other information about the environment of the light source and/or the VLC-compatible device that is receiving the light source's VLC signal.

In some embodiments, the identification made at block 1405 may be made or facilitated by the VLC module 410 of the light source 205 described with reference to FIG. 4 and/or 8, or by the codeword identification module 505 of the light source 205 described with reference to FIG. 5, 6, and/or 7.

At block 1410, the codeword may be repetitively transmitted in a VLC signal while, from one transmission of the codeword to a next transmission of the codeword, imparting changes in timings of the symbols of the codeword relative to a timing reference of an image capture frame of an image sensor configured to receive the codeword. In some cases, imparting changes in timings of the symbols of the codeword relative to the timing reference of the image sensor may include changing positions of the plurality of symbols within the codeword using a permutation function. The permutation function may, for example, pseudo-randomly change positions of the plurality of symbols within the codeword or cyclically shift positions of the plurality of symbols within the codeword. In other cases, imparting changes in timings of the symbols of the codeword relative to the timing reference of the image capture frame of the image sensor may include identifying a codeword having a transmission time that differs from (e.g., is shorter or longer than) a frame duration of the image capture frame of the image sensor. In this manner, the transmission of instances of the codeword back-to-back may cause the timings of the symbols within the codeword to change with respect to the timing reference of the image capture frame of the image sensor. In some cases, the timing reference may be a periodic start time of the image capture frame.

The changes in the timings of the symbols may help to account for erasures of codeword symbols, at a receiver of a VLC-compatible device 115, due to temporary outages in a VLC link (e.g., as a result of physical obstructions, or as a result of an increase in the distance between a VLC source and the receiver of the VLC-compatible device 115).

In some cases, each instance of the codeword may be transmitted as a sequence of pulses in time, with each pulse representing a symbol that conveys at least one bit of information. In some cases, the position of a pulse within a symbol period may convey the at least one bit of information (e.g., the codeword may be transmitted as a binary PPM codeword).

In some embodiments, the repetitive transmissions of the codeword may be made by the repetitive transmission module 510 of the light source 205 described with reference to FIG. 5, by the transmitter module 415 of the light source 205 described with reference to FIG. 5, 6, and/or 7, or by the transceiver module 810 of the light source 205 described with reference to FIG. 8.

Therefore, the method 1400 may be used for transmitting data using rateless VLC. It should be noted that the method 1400 is just one implementation and that the operations of the method 1400 may be rearranged or otherwise modified such that other implementations are possible.

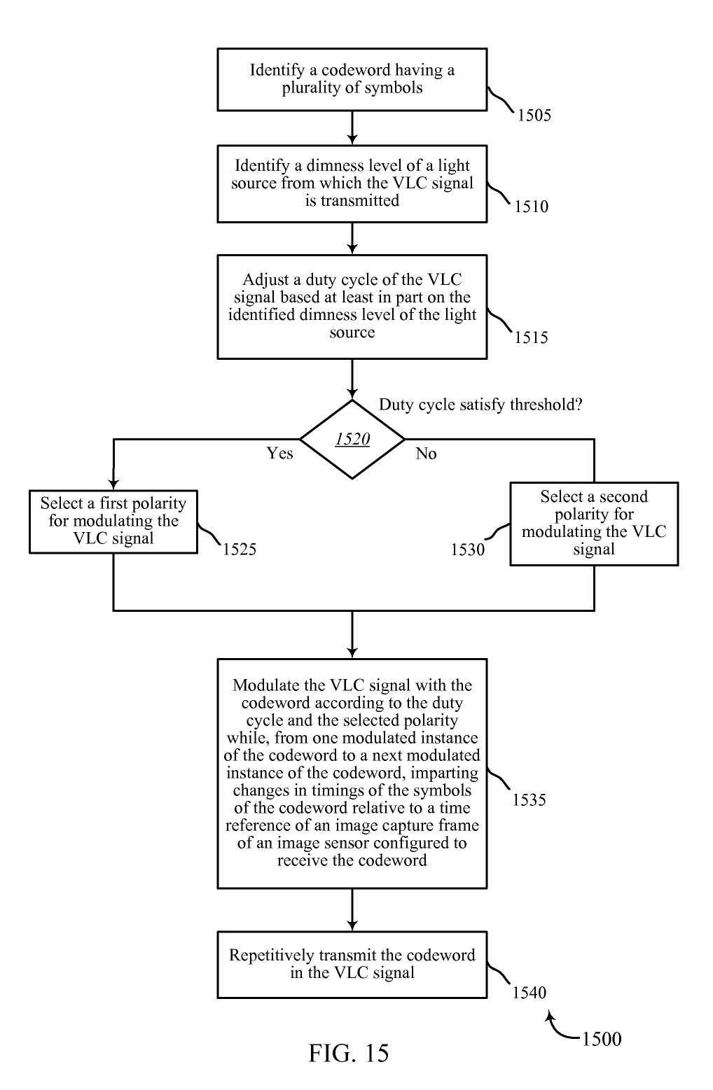

FIG. 15 is a flow chart illustrating another embodiment of a method 1500 for transmitting data using rateless VLC. For clarity, the method 1500 is described below with reference to one of the light sources 205 described with reference to FIG. 1, 2, 3, 4, 5, 6, 7, and/or 8. In one embodiment, the method 1500 may be an implementation of the method 1400 described with reference to FIG. 14. In one implementation, the VLC module 410 described with reference to FIG. 4, 5, 6, 7 and/or 8 may execute one or more sets of codes to control the functional elements of a light source 205 to perform the functions described below.

At block 1505, a codeword having a plurality of symbols may be identified. In some cases, the codeword may encode an identifier, such as a MAC address, that uniquely identifies a particular light source. In other cases, the codeword may encode a non-unique identifier that has a high probability of being unique within a particular geographic region. In still other cases, the codeword may encode one of a smaller set of codewords. Less unique identifiers may be mapped to codewords that are shorter in duration, which codewords may be less complicated to transmit or receive. However, unique identifiers have the advantage of being able to uniquely identify a light source in the absence of accessing other information about the environment of the light source and/or the VLC-compatible device that is receiving the light source's VLC signal.

In some embodiments, the identification made at block 1405 may be made or facilitated by the VLC module 410 of the light source 205 described with reference to FIG. 4 and/or 8, or by the codeword identification module 505 of the light source 205 described with reference to FIG. 5, 6, and/or 7.

At block 1510, a dimness level of the light source from which the VLC signal is transmitted may be identified. In some embodiments, the identification made at block 1510 may be made or facilitated by the VLC module 410 of the light source 205 described with reference to FIG. 4, 5, 6, and/or 8, or by the dimness identification module 705 described with reference to FIG. 7.

At block 1515, a duty cycle of the VLC signal may be adjusted based at least in part on the identified dimness level of the light source 205. In some embodiments, the adjustment made at block 1510 may be made or facilitated by the VLC module 410 of the light source 205 described with reference to FIG. 4, 5, 6, and/or 8, or by the duty cycle adjustment module 710 described with reference to FIG. 7.

At block 1520, it may be determined whether the duty cycle of the VLC signal satisfies a threshold. Upon determining that the duty cycle satisfies the threshold (e.g., is greater than the threshold, such as greater than 50%) at block 1525, a first polarity may be selected for modulating the VLC signal. Upon determining that the duty cycle fails to satisfy the threshold (e.g., is equal to or below the threshold, such as equal to or below 50%) at block 1530, a second polarity may be selected for modulating the VLC signal. The second plurality may be opposite from the first polarity.

In some embodiments, the first polarity used to modulate the VLC signal (e.g., when the duty cycle of the VLC signal is determined to be greater than a threshold at block 1525) may result in each pulse of the VLC signal being defined by a high to low transition followed by a low to high transition, and the second polarity used to modulate the VLC signal (e.g., when the duty cycle of the VLC signal is determined to be equal to or below the threshold at block 1530) may result in each pulse of the VLC signal being defined by a low to high transition followed by a high to low transition.

At block 1535, the VLC signal may be modulated with the identified codeword. The VLC signal may be modulated according to the adjusted duty cycle and the selected polarity.

The VLC signal may be modulated while, from one modulated instance of the codeword to a next modulated instance of the codeword, imparting changes in timings of the symbols of the codeword relative to a timing reference of an image capture frame of an image sensor configured to receive the codeword. In some cases, imparting changes in timings of the symbols of the codeword relative to the timing reference of the image sensor may include changing positions of the plurality of symbols within the codeword using a permutation function. The permutation function may, for example, pseudo-randomly change positions of the plurality of symbols within the codeword or cyclically shift positions of the plurality of symbols within the codeword. In other cases, imparting changes in timings of the symbols of the codeword relative to the timing reference of the image capture frame of the image sensor may include identifying a codeword having a transmission time that differs from (e.g., is shorter or longer than) a frame duration of the image capture frame of the image sensor. In this manner, the transmission of instances of the codeword back-to-back may cause the timings of the symbols within the codeword to change with respect to the timing reference of the image capture frame of the image sensor. In some cases, the timing reference may be a periodic start time of the image capture frame.

The changes in the timings of the symbols may help to account for erasures of codeword symbols, at a receiver of a VLC-compatible device 115, due to temporary outages in a VLC link (e.g., as a result of physical obstructions, or as a result of an increase in the distance between a VLC source and the receiver of the VLC-compatible device 115).

The symbols of the codeword may in some cases be pulse position modulated. In one example of a PPM codeword, a logic “0” may be represented by a pulse aligned with one boundary of a pulse timeslot, and a logic “1” may be represented by a pulse that is centered within a pulse timeslot. Alternately, the representations for logic “0” and logic “1” may be reversed.

In some cases, the VLC signal may also be modulated with a repetitively transmitted synchronization signal, such that transmissions of the codeword are associated with transmissions of the synchronization signal. In some embodiments, the synchronization signal may include at least two pulses, of which any two consecutive pulses have a spacing in time that differs from both 1) a spacing in time between any two consecutive pulses of the codeword, and 2) a spacing in time between a pulse of the synchronization signal and a pulse of the codeword. This may enable the synchronization signal to be distinguished from the symbols of the codeword when received by a VLC-compatible device 115. In some embodiments, each transmission of the synchronization signal may precede a transmission of the codeword, thereby enabling a VLC-compatible device 115 to synchronize with the synchronization signal before decoding the symbols of the codeword.

In some embodiments, the modulation performed at block 1535 may be performed by the VLC module 410 of the light source 205 described with reference to FIG. 4 and/or 8, or by the codeword identification module of the light source 205 described with reference to FIG. 5, 6, and/or 7.

At block 1540, the codeword may be repetitively transmitted in the VLC signal. In some cases, each instance of the codeword may be transmitted as a sequence of pulses in time, with each pulse representing a symbol that conveys at least one bit of information. In some cases, the position of a pulse within a symbol period may convey the at least one bit of information (e.g., the codeword may be transmitted as a binary PPM codeword).

In some cases, the codeword may be repetitively transmitted by modulating the VLC signal with pulses having the first duty cycle and the first polarity. However, when it is determined that the first duty cycle has been adjusted to the second duty cycle (e.g., when it is determined that the duty cycle of the VLC signal has been adjusted from a duty cycle greater than 50% to a duty cycle equal to or below 50%), the polarity of the pulses may be switched from the first polarity to the second polarity, and the codeword may be repetitively transmitted by modulating the VLC signal with pulses having the second duty cycle and the second polarity.

Similarly, the codeword may be repetitively transmitted by modulating the VLC signal with pulses having the second duty cycle and the second polarity. However, when it is determined that the second duty cycle has been adjusted to the first duty cycle (e.g., when it is determined that the duty cycle of the VLC signal has been adjusted from a duty cycle equal to or below 50% to a duty cycle greater than 50%), the polarity of the pulses may be switched from the second polarity to the first polarity, and the codeword may be repetitively transmitted by modulating the VLC signal with pulses having the first duty cycle and the first polarity.

In some embodiments, the repetitive transmissions of the codeword may be made by the repetitive transmission module 510 of the light source 205 described with reference to FIG. 5, by the transmitter module 415 of the light source 205 described with reference to FIG. 5, 6, and/or 7, or by the transceiver module 810 of the light source 205 described with reference to FIG. 8.

Therefore, the method 1500 may be used for transmitting data using rateless VLC. It should be noted that the method 1500 is just one implementation and that the operations of the method 1500 may be rearranged or otherwise modified such that other implementations are possible.

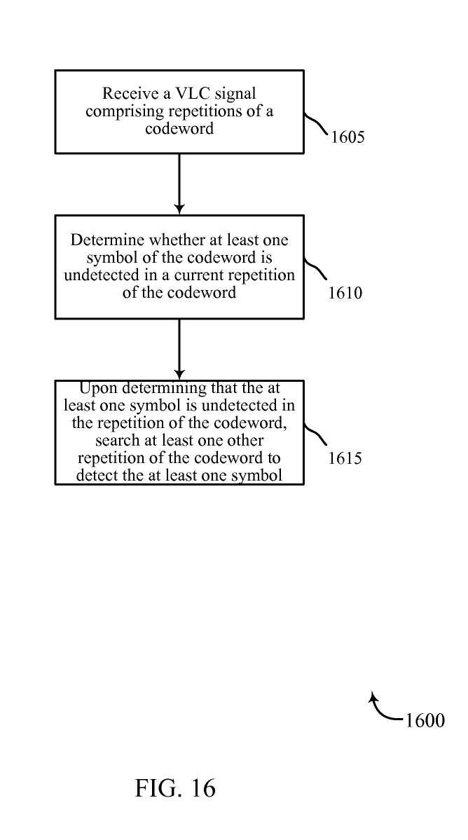

FIG. 16 is a flow chart illustrating an embodiment of a method 1600 for receiving rateless VLCs. For clarity, the method 1600 is described below with reference to one of the VLC-compatible devices 115 described with reference to FIG. 1, 2, 3, 9, 10, and/or 11. In one implementation, the UE VLC module 910 described with reference to FIG. 9 and/or 10, or the reconstruction module 1150 described with reference to FIG. 11, may execute one or more sets of codes to control the functional elements of a VLC-compatible device 115 to perform the functions described below.

At block 1605, a VLC signal including repetitions of a codeword may be received. In some embodiments, the VLC signal may also include repetitions of a synchronization signal. In some cases, each repetition of the codeword may be associated with a repetition of the synchronization signal. When a synchronization signal is received, a timing of one or more symbols of the codeword may be determined based at least in part on the synchronization signal.

In some embodiments, the VLC signal may be received by a UE receiver module of a VLC-compatible device, such as one of the UE receiver modules 905 of one of the VLC-compatible devices 115 described with reference to FIG. 9, 10, and/or 11. In some embodiments, the VLC signal may also be received via a CMOS image sensor (e.g., via the image sensor 1155). The CMOS image sensor may be a part of, or associated with, a receiver module of a VLC-compatible device.

At block 1610, it may be determined whether at least one symbol of the codeword is undetected in a repetition of the codeword. In some embodiments, the determination made at block 1610 may be made or facilitated by the UE VLC module 910 described with reference to FIG. 9, the symbol detection module 1005 described with reference to FIG. 10, or the reconstruction module 1150 described with reference to FIG. 11.

At block 1615, and upon determining that the at least one symbol is undetected in the repetition of the codeword, at least one other repetition of the codeword may be searched to detect the at least one symbol. In some embodiments, the search performed at block 1615 may be undertaken or managed by the UE VLC module 910 described with reference to FIG. 9, the synchronization signal identification module 1015 described with reference to FIG. 10, or the reconstruction module 1150 described with reference to FIG. 11.

When detecting the symbols of the codeword, changes in timings of the symbols of the codeword relative to a timing reference of an image capture frame of an image sensor at which the codeword is received may be identified. The changes in timings may be identified at least in part based on timings of the synchronization signal with respect to the timing reference of the image capture frame. The changes in timings may occur from one received repetition of the codeword to a next received repetition of the codeword. The changes in the timings of the symbols may help to account for erasures of codeword symbols due to temporary outages in a VLC link (e.g., as a result of physical obstructions, or as a result of an increase in the distance between a VLC source and the receiver of a VLC-compatible device 115).

After detecting the symbols of the codeword in one or more repetitions of the codeword, the codeword may be reconstructed based at least in part on the detected symbols.

Therefore, the method 1600 may be used for receiving rateless VLCs. It should be noted that the method 1600 is just one implementation and that the operations of the method 1600 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS. LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARM) to provide retransmission at the MAC layer to improve link efficiency. At the Physical layer, the transport channels may be mapped to Physical channels.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration. A processor may in some cases be in electronic communication with a memory, where the memory stores instructions that are executable by the processor.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

A computer program product or computer-readable medium both include a computer-readable storage medium and communication medium, including any mediums that facilitates transfer of a computer program from one place to another. A storage medium may be any medium that can be accessed by a general purpose or special purpose computer. By way of example, and not limitation, computer-readable medium can comprise RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for transmitting data using rateless visible light communication (VLC), comprising:
identifying a codeword having a plurality of symbols; and
repetitively transmitting the codeword in a VLC signal while, from one transmission of the codeword to a next transmission of the codeword, imparting changes in timings of the symbols of the codeword relative to a timing reference of an image capture frame of an image sensor configured to receive the codeword.

2. The method of claim 1, wherein imparting changes in timings of the symbols of the codeword relative to the timing reference of the image capture frame of the image sensor comprises:
changing positions of the plurality of symbols within the codeword using a permutation function.

3. The method of claim 2, wherein the permutation function pseudo-randomly changes positions of the plurality of symbols within the codeword.

4. The method of claim 2, wherein the permutation function cyclically shifts positions of the plurality of symbols within the codeword.

5. The method of claim 1, wherein imparting changes in timings of the symbols of the codeword relative to the timing reference of the image capture frame of the image sensor comprises:
identifying a codeword having a transmission time that differs from a frame duration of the image capture frame of the image sensor.

6. The method of claim 5, wherein the transmission time of the codeword is shorter than the frame duration.

7. The method of claim 1, wherein repetitively transmitting the codeword comprises:
transmitting instances of the codeword back-to-back.

8. The method of claim 1, wherein the timing reference of the image capture frame is a periodic start time of the image capture frame.

9. The method of claim 1, wherein the codeword is transmitted as a sequence of pulses in time, each pulse representing a symbol that conveys at least one bit of information.

10. The method of claim 9, further comprising:
identifying a dimness level of a light source from which the VLC signal is transmitted; and
adjusting a duty cycle of the VLC signal based at least in part on the identified dimness level of the light source.

11. The method of claim 10, further comprising:
determining whether the duty cycle of the VLC signal exceeds a threshold.

12. The method of claim 11, further comprising:
upon determining that the duty cycle exceeds the threshold, repetitively transmitting the codeword by modulating the VLC signal with pulses having a first polarity; and
upon determining that the duty cycle fails to exceed the threshold, repetitively transmitting the codeword by modulating the VLC signal with pulses having a second polarity, the second polarity being opposite from the first polarity.

13. The method of claim 12, wherein:
the pulses having the first polarity comprises a high to low transition followed by a low to high transition; and
the pulses having the second polarity comprise a low to high transition followed by a high to low transition.

14. The method of claim 9, wherein a position of a pulse within a symbol period conveys the at least one bit of information.

15. The method of claim 1, further comprising:
repetitively transmitting a synchronization signal, wherein each transmission of the codeword is associated with a transmission of the synchronization signal.

16. The method of claim 15, wherein:
the codeword is transmitted as a sequence of pulses in time, each pulse representing a symbol that conveys at least one bit of information; and
the synchronization signal comprises at least two pulses, of which any two consecutive pulses have a spacing in time that differs from a spacing in time between any two consecutive pulses of the codeword, and that differs from a spacing in time between a pulse of the synchronization signal and a pulse of the codeword.

17. The method of claim 15, wherein a transmission of the synchronization signal precedes a transmission of the codeword.

18. The method of claim 1, wherein the codeword comprises a binary pulse position modulated (PPM) codeword.

19. The method of claim 1, wherein the codeword encodes an identifier uniquely identifying a light source.

20. An apparatus for transmitting data using rateless visible light communication (VLC), comprising:
means for identifying a codeword having a plurality of symbols; and
means for repetitively transmitting the codeword in a VLC signal while, from one transmission of the codeword to a next transmission of the codeword, imparting changes in timings of the symbols of the codeword relative to a timing reference of an image capture frame of an image sensor configured to receive the codeword.

21. The apparatus of claim 20, wherein imparting changes in timings of the symbols of the codeword relative to the timing reference of the image capture frame of the image sensor comprises:
changing positions of the plurality of symbols within the codeword using a permutation function.

22. The apparatus of claim 21, wherein the permutation function pseudo-randomly changes positions of the plurality of symbols within the codeword.

23. The apparatus of claim 21, wherein the permutation function cyclically shifts positions of the plurality of symbols within the codeword.

24. The apparatus of claim 20, wherein imparting changes in timings of the symbols of the codeword relative to the timing reference of the image capture frame of the image sensor comprises:
identifying a codeword having a transmission time that differs from a frame duration of the image capture frame of the image sensor.

25. The apparatus of claim 24, wherein the transmission time of the codeword is shorter than the frame duration.

26. The apparatus of claim 20, wherein the means for repetitively transmitting the codeword comprises:
means for transmitting instances of the codeword back-to-back.

27. The apparatus of claim 20, wherein the timing reference of the image capture frame is a periodic start time of the image capture frame.

28. The apparatus of claim 20, wherein the codeword is transmitted as a sequence of pulses in time, each pulse representing a symbol that conveys at least one bit of information.

29. The apparatus of claim 20, further comprising:
means for identifying a dimness level of a light source from which the VLC signal is transmitted; and
means for adjusting a duty cycle of the VLC signal based at least in part on the identified dimness level of the light source.

30. The apparatus of claim 29, further comprising:
means for determining whether the duty cycle of the VLC signal exceeds a threshold.

31. The apparatus of claim 30, further comprising:
means for, upon determining that the duty cycle exceeds the threshold, repetitively transmitting the codeword by modulating the VLC signal with pulses having a first polarity; and
means for, upon determining that the duty cycle fails to exceed the threshold, repetitively transmitting the codeword by modulating the VLC signal with pulses having a second polarity, the second polarity being opposite from the first polarity.

32. The apparatus of claim 31, wherein:
the pulses having the first polarity comprises a high to low transition followed by a low to high transition; and
the pulses having the second polarity comprise a low to high transition followed by a high to low transition.

33. The apparatus of claim 32, wherein a position of a pulse within a symbol period conveys the at least one bit of information.

34. The apparatus of claim 20, further comprising:
means for repetitively transmitting a synchronization signal, wherein each transmission of the codeword is associated with a transmission of the synchronization signal.

35. The apparatus of claim 34, wherein:
the codeword is transmitted as a sequence of pulses in time, each pulse representing a symbol that conveys at least one bit of information; and
the synchronization signal comprises at least two pulses, of which any two consecutive pulses have a spacing in time that differs from a spacing in time between any two consecutive pulses of the codeword, and that differs from a spacing in time between a pulse of the synchronization signal and a pulse of the codeword.

36. The apparatus of claim 34, wherein a transmission of the synchronization signal precedes a transmission of the codeword.

37. The apparatus of claim 20, wherein the codeword comprises a binary pulse position modulated (PPM) codeword.

38. The apparatus of claim 20, wherein the codeword encodes an identifier uniquely identifying a light source.

39. Apparatus for transmitting data using rateless visible light communication (VLC), comprising:
a processor;
memory in electronic communication with the processor; and
instructions stored in the memory, the instructions being executable by the processor to:
identify a codeword having a plurality of symbols; and
repetitively transmit the codeword in a VLC signal while, from one transmission of the codeword to a next transmission of the codeword, imparting changes in timings of the symbols of the codeword relative to a timing reference of an image capture frame of an image sensor configured to receive the codeword.

40. The apparatus of claim 39, wherein imparting changes in timings of the symbols of the codeword relative to the timing reference of the image capture frame of the image sensor comprises:
changing positions of the plurality of symbols within the codeword using a permutation function.

41. The apparatus of claim 39, wherein imparting changes in timings of the symbols of the codeword relative to the timing reference of the image capture frame of the image sensor comprises:
identifying a codeword having a transmission time that differs from a frame duration of the image capture frame of the image sensor.

42. The apparatus of claim 41, wherein the transmission time of the codeword is shorter than the frame duration.

43. The apparatus of claim 39, wherein the instructions executable by the processor to repetitively transmit the codeword comprise:
instructions executable by the processor to transmit instances of the codeword back-to-back.

44. The apparatus of claim 39, wherein the codeword is transmitted as a sequence of pulses in time, each pulse representing a symbol that conveys at least one bit of information.

45. The apparatus of claim 39, wherein the instructions are executable by the processor to:
identify a dimness level of a light source from which the VLC signal is transmitted; and
adjust a duty cycle of the VLC signal based at least in part on the identified dimness level of the light source.

46. The apparatus of claim 45, wherein the instructions are executable by the processor to:
determine whether the duty cycle of the VLC signal exceeds a threshold.

47. The apparatus of claim 46, wherein the instructions are executable by the processor to:
upon determining that the duty cycle exceeds the threshold, repetitively transmit the codeword by modulating the VLC signal with pulses having a first polarity; and
upon determining that the duty cycle fails to exceed the threshold, repetitively transmit the codeword by modulating the VLC signal with pulses having a second polarity, the second polarity being opposite from the first polarity.

48. The apparatus of claim 39, wherein the instructions are executable by the processor to:
repetitively transmit a synchronization signal, wherein each transmission of the codeword is associated with a transmission of the synchronization signal.

49. The apparatus of claim 39, wherein the codeword comprises a binary pulse position modulated (PPM) codeword.

50. The apparatus of claim 39, wherein the codeword encodes an identifier uniquely identifying a light source.

51. A computer program product for transmitting data using rateless visible light communication (VLC), the computer program product comprising a non-transitory computer-readable medium storing instructions executable by a processor to:
identify a codeword having a plurality of symbols; and
repetitively transmit the codeword in a VLC signal while, from one transmission of the codeword to a next transmission of the codeword, imparting changes in timings of the symbols of the codeword relative to a timing reference of an image capture frame of an image sensor configured to receive the codeword.

52. The computer program product of claim 51, wherein imparting changes in timings of the symbols of the codeword relative to the timing reference of the image capture frame of the image sensor comprises:
changing positions of the plurality of symbols within the codeword using a permutation function.

53. The computer program product of claim 51, wherein imparting changes in timings of the symbols of the codeword relative to the timing reference of the image capture frame of the image sensor comprises:
identifying a codeword having a transmission time that differs from a frame duration of the image capture frame of the image sensor.

54. The computer program product of claim 51, wherein the codeword comprises a binary pulse position modulated (PPM) codeword.

55. A method for receiving data using rateless visible light communication (VLC), comprising:
receiving a VLC signal comprising repetitions of a codeword, the codeword having a plurality of symbols;
determining whether at least one symbol of the codeword is undetected in a repetition of the codeword; and
upon determining that the at least one symbol is undetected in the repetition of the codeword, searching at least one other repetition of the codeword to detect the at least one symbol.

56. The method of claim 55, further comprising:
from one received repetition of the codeword to a next received repetition of the codeword, identifying changes in timings of the symbols of the codeword relative to a timing reference of an image capture frame of an image sensor at which the codeword is received.

57. The method of claim 55, wherein the received VLC signal comprises repetitions of a synchronization signal, the method further comprising:
determining a timing of one or more symbols of the codeword based at least in part on the synchronization signal.

58. The method of claim 57, further comprising:
from one received repetition of the codeword to a next received repetition of the codeword, identifying changes in timings of the symbols of the codeword relative to a timing reference of an image capture frame of an image sensor at which the codeword is received, the changes in timings identified at least in part based on timings of the repetitions of the synchronization signal with respect to the timing reference of the image capture frame.

59. The method of claim 55, further comprising:
reconstructing the codeword based at least in part on symbols of the codeword detected in different repetitions of the codeword.

60. The method of claim 55, further comprising:
receiving the VLC signal via a complementary metal-oxide semiconductor (CMOS) image sensor.

61. An apparatus for receiving data using rateless visible light communication (VLC), comprising:
means for receiving a VLC signal comprising repetitions of a codeword, the codeword having a plurality of symbols;
means for determining whether at least one symbol of the codeword is undetected in a repetition of the codeword; and
means for, upon determining that the at least one symbol is undetected in the repetition of the codeword, searching at least one other repetition of the codeword to detect the at least one symbol.

62. The apparatus of claim 61, further comprising:
means for, from one received repetition of the codeword to a next received repetition of the codeword, identifying changes in timings of the symbols of the codeword relative to a timing reference of an image capture frame of an image sensor at which the codeword is received.

63. The apparatus of claim 61, wherein the received VLC signal comprises repetitions of a synchronization signal, the apparatus further comprising:
means for determining a timing of one or more symbols of the codeword based at least in part on the synchronization signal.

64. The apparatus of claim 63, further comprising:
means for, from one received repetition of the codeword to a next received repetition of the codeword, identifying changes in timings of the symbols of the codeword relative to a timing reference of an image capture frame of an image sensor at which the codeword is received, the changes in timings identified at least in part based on timings of the repetitions of the synchronization signal with respect to the timing reference of the image capture frame.

65. The apparatus of claim 61, further comprising:
means for reconstructing the codeword based at least in part on symbols of the codeword detected in different repetitions of the codeword.

66. The apparatus of claim 61, further comprising:
means for receiving the VLC signal via a complementary metal-oxide semiconductor (CMOS) image sensor.

67. Apparatus for receiving data using rateless visible light communication (VLC), comprising:
a processor;
memory in electronic communication with the processor; and
instructions stored in the memory, the instructions being executable by the processor to:
receive a VLC signal comprising repetitions of a codeword, the codeword having a plurality of symbols;
determine whether at least one symbol of the codeword is undetected in a repetition of the codeword; and
upon determining that the at least one symbol is undetected in the repetition of the codeword, search at least one other repetition of the codeword to detect the at least one symbol.

68. The apparatus of claim 67, wherein the instructions are executable by the processor to:
from one received repetition of the codeword to a next received repetition of the codeword, identify changes in timings of the symbols of the codeword relative to a timing reference of an image capture frame of an image sensor at which the codeword is received.

69. The apparatus of claim 67, wherein the instructions are executable by the processor to:
reconstruct the codeword based at least in part on symbols of the codeword detected in different repetitions of the codeword.

70. The apparatus of claim 67, wherein the instructions are executable by the processor to:
receive the VLC signal via a complementary metal-oxide semiconductor (CMOS) image sensor.

71. A computer program product for receiving data using rateless visible light communication (VLC), the computer program product comprising a non-transitory computer-readable medium storing instructions executable by a processor to:
receive a VLC signal comprising repetitions of a codeword, the codeword having a plurality of symbols;
determine whether at least one symbol of the codeword is undetected in a repetition of the codeword; and
upon determining that the at least one symbol is undetected in the repetition of the codeword, search at least one other repetition of the codeword to detect the at least one symbol.

72. The computer program product of claim 71, wherein the instructions are executable by the processor to:
from one received repetition of the codeword to a next received repetition of the codeword, identify changes in timings of the symbols of the codeword relative to a timing reference of an image capture frame of an image sensor at which the codeword is received.

73. The computer program product of claim 71, wherein the instructions are executable by the processor to:
reconstruct the codeword based at least in part on symbols of the codeword detected in different repetitions of the codeword.
